(19) United States
(12) Patent Application Publication
(10) Pub. No.: US 2017/0264427 A1
(43) Pub. Date: Sep. 14, 2017

(54) DATA ENCRYPTION TECHNIQUES

(71) Applicant: Microsoft Technology Licensing, LLC, Redmond, WA (US)

(72) Inventor: William K. Hollis, Duvall, WA (US)

(21) Appl. No.: 15/068,214

(22) Filed: Mar. 11, 2016

(51) Int. Cl. H04L 9/06

(52) U.S. Cl. CPC H04L 9/065; H04L 9/0668

(57) ABSTRACT

System and methods for encrypting data, such as plaintext or binary data, on electronic devices are described. An electronic device can encrypt the data by receiving a string of one or more characters associated with the data to be encrypted, determining an entropy for an encrypted string, determining a position for each character of the one or more characters, generating an encrypted string for each character using the determined entropy and position of the respective character, and generating an encrypted message by concatenating the encrypted strings of the one or more characters together. In some examples, the electronic device encrypts the data using one or more pseudo-random number generators. In some examples, the electronic device can offset the one or more characters before the encrypting and/or offset characters in the encrypted strings after the encrypting. The electronic device can then send the encrypted message to another electronic device for decrypting.

### BACKGROUND

Electronic devices use encryption to encode messages and information in such a way that only authorized parties can read it. To encrypt a message or information, the message or information is encrypted using an encryption algorithm in order to generate an encrypted data, which can only be read if decrypted. Many types of encryption schemes use an encryption key generated by the encryption algorithm to encrypt data. In such encryption schemes, it is almost impossible to decrypt the encrypted data without being in possession of the generated encryption key.

Current encryption schemes (e.g., elliptic curve cryptography) typically require an appreciable amount of computing resources, such as processing power and memory storage, because of the complexity of the encryption algorithms and/or the size of the encryption keys that the encryption schemes use to encrypt data. Furthermore, when two electronic devices communicate using encrypted messages, current encryption schemes typically require the use of a third-party (e.g., third-party server) to validate each other before the electronic devices are able to communicate using the encrypted messages.

### SUMMARY

This disclosure describes data encryption techniques. In some examples, an electronic device can use an encryption tool to encrypt data, such as plaintext or binary data. The plaintext can include a string of one or more characters, such as letters, numbers, symbols, punctuation marks, spaces, or the like. The binary data can also be represented as a string of characters, that is, a string characters that includes zeros and ones. To encrypt the data, the encryption tool can use a pseudo-random number generator and seed (and/or password) to determine, for at least one character of the data to be encrypted, an entropy (i.e., first random number) associated with an encrypted string and a position (i.e., second random number) within the encrypted string for the respective character. The encryption tool can then place the respective character at the determined position within the encrypted string and place random characters at remaining positions within the encrypted string. In some examples, the encryption tool concatenates encrypted strings of characters in order to generate an encrypted message. The electronic device then sends the encrypted message to another electronic device, which can decrypt the encrypted message using the same pseudo-random number generator and seed.

In some examples, the encryption tool can offset one or more characters of the data to be encrypted before encrypting the data. Additionally or alternatively, in some examples, the encryption tool can offset one or more characters of the encrypted strings. To offset a character, the encryption tool can determine a value that is associated with the character, offset the value using one or more mathematical operations (e.g., adding, subtracting, multiplication, division, etc.) in order to generate a new value, and then determine a new character based on the new number. The encryption tool can then offset the character in the data to be encrypted and/or the encrypted strings by replacing the character with the new character.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram illustrating an example environment in which data encryption techniques can operate.

FIG. 2 is a block diagram illustrating an example environment in which data encryption techniques can operate using peripheral devices of a computing device.

FIGS. 3A-3B are a block diagram illustrating an example of utilizing data encryption techniques.

FIG. 4 is a block diagram illustrating an example computing device configured to utilize data encryption techniques.

FIGS. 5A-5C are a pictorial flow diagram of an example method for encrypting data in order to generate an encrypted message.

FIG. 6 is a pictorial flow diagram of an example method for replacing characters in an encrypted string.

FIGS. 7A-7B are a pictorial flow diagram of an example method for decrypting an encrypted message.

FIGS. 8A-8B are a pictorial flow diagram of another example method for encrypting data in order to generate an encrypted message.

FIGS. 9A-9C are a pictorial flow diagram of another example method for decrypting an encrypted message.

FIG. 10 is a pictorial flow diagram of an example method for offsetting characters of data before encrypting the data.

FIG. 11 is a flow diagram of an example method for offsetting characters in an encrypted string and/or encrypted message.

### DETAILED DESCRIPTION

### Overview

Examples described herein provide techniques for encrypting data using an encryption tool. Data to be encrypted can include plaintext, binary data, or any other data that includes a string of characters. For example, plaintext can include a string of one or more characters, such as letters, numbers, symbols, punctuation marks, spaces, or the like. Binary data can also be represented as a string of one or more characters, specifically including zeros and ones.

In some examples, a first electronic device can communicate with a second electronic device using encrypted messages (i.e., encrypted data). To encrypt data, the first electronic device uses a pseudo-random number generator and a seed. In some examples, the seed can be automatically generated by each electronic device. For instance, the seed can be based on time when the electronic devices start to communicate, and can change based on a length of time associated with the communication. In some examples, the seed can be based on a password that is input into each electronic device. For instance, users of each electronic device may input an agreed upon password into the electronic devices. In some examples, the password can also be used to determine the formula used in conjunction with the pseudo-random number generator or used on its own as the formula for generating numbers. For example, a contains letter “L” in the password may mean “skip every other number”, an “R” in the password may mean “divide the number by two.”

As discussed above, in some examples, the data to be encrypted can include a string of one or more characters. To encrypt the data, the first electronic device can use the encryption tool to generate an encrypted string for each of one or more characters of the data. In an example implementation, to generate an encrypted string for a character, the encryption tool determines two random numbers for the encrypted string of the character. For instance, the encryption tool can use the pseudo-random number generator to determine an individual entropy for the encrypted string that is based on an entropy for the data. The individual entropy can define a number positions (i.e., a length) associated with the encrypted string. The encryption tool can further use the pseudo-random number generator to determine a position for the character within the encrypted string.

After determining the individual entropy and the position for the encrypted string, the encryption tool can place the character to be encrypted at the determined position within the encrypted string. The encryption tool can further use the pseudo-random number generator to generate and place random characters at each of the remaining positions within the encrypted string. In some examples, if a generated random character is the same as the character to be encrypted, the generated random character is not added to the encrypted string and the encryption tool uses the pseudo-random number generator to generate a new random number.

In some examples, the encryption tool can also offset each of one or more of the characters in the data to be encrypted or in the encrypted string. For instance, the encryption tool can determine a value for each of the one or more characters (such as by using an American Standard Code for Information Interchange (ASCII) table) in the data to be encrypted and/or the encrypted string, offset each determined value using one or more mathematical operations (e.g., addition, subtraction, multiplication, division, etc.) in order to determine a new respective value, determine a new character based on the new respective value, and replace the one or more characters within the data to be encrypted or the encrypted string using the new characters. Additionally or alternatively, in some examples, the encryption tool can offset one or more characters of the data to be encrypted and/or the encrypted string before, during, or after generating the encrypted strings.

In some examples, the encryption tool uses the encrypted strings generated from the data to generate an encrypted message. To generate the encrypted message, the encryption tool can concatenate the encrypted strings together. The first electronic device that generates the encrypted message can then send the encrypted message to the second electronic device. The second electronic device can use a local copy of the pseudo-random number generator to decrypt the encrypted message in order to generate the data. In some examples, the electronic devices can continue to generate encrypted messages using the method above, send the encrypted messages to each other, and decrypt the encrypted messages.

It should be noted that, in some examples, the electronic devices may use more than one pseudo-random number generator when generating encrypted messages. For example, an encryption tool can use more than one pseudo-random number generator to encrypt and/or decrypt data. For instance, the encryption tool can use a different pseudo-random number generator to encrypt each of one or more characters of the data. For another example, an encryption tool of a first electronic device may use one or more first pseudo-random number generators to encrypt data and one or more second pseudo-random number generators to decrypt encrypted messages received from a second electronic device, and an encryption tool of the second electronic device can use the one or more first pseudo-random number generators to decrypt encrypted messages received from the first electronic device and the one or more second pseudo-random number generators to encrypt data.

By only requiring a pseudo-random number generator and minimal logic to encrypt and/or decrypt data, an electronic device configured to implement the data encryption techniques described herein does not require substantial processing power and/or memory space to utilize the encryption tool. For instance, in some examples, the electronic device does not have to generate keys for encrypting data, which can require significant processing power. As such, low-resource devices and/or peripheral devices can utilize the encryption tool described herein to encrypt and/or decrypt data. Additionally, since the encryption tool only requires a seed (and/or password) to synchronize electronic devices together, the encryption tool allows the electronic devices to communicate with each other without requiring a third-party service to validate the electronic devices.

### Illustrative Environment

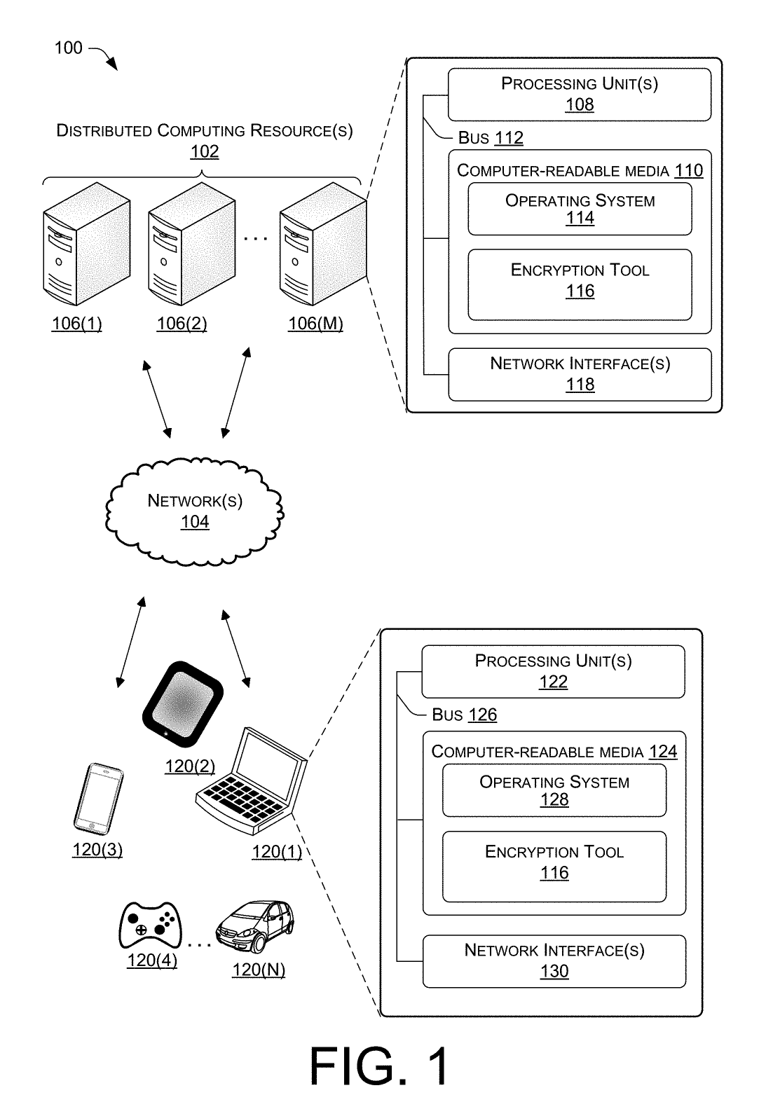

FIG. 1 shows an example environment 100 in which examples of data encryption techniques can operate. In some examples, the various devices and/or components of environment 100 include distributed computing resources 102 that can communicate with one another and with external devices via one or more networks 104.

Network(s) 104 can include, for example, public networks such as the Internet, private networks such as an institutional and/or personal intranet, or some combination of private and public networks. Network(s) 104 can also include any type of wired and/or wireless network, including but not limited to local area networks (LANs), wide area networks (WANs), satellite networks, cable networks, Wi-Fi networks, WiMax networks, mobile communications networks (e.g., 3G, 4G, and so forth) or any combination thereof. Network(s) 104 can utilize communications protocols, including packet-based and/or datagram-based protocols such as internet protocol (IP), transmission control protocol (TCP), user datagram protocol (UDP), or other types of protocols. Moreover, network(s) 104 can also include a number of devices that facilitate network communications and/or form a hardware basis for the networks, such as switches, routers, gateways, access points, firewalls, base stations, repeaters, backbone devices, and the like.

In some examples, network(s) 104 can further include devices that enable connection to a wireless network, such as a wireless access point (WAP). Examples support connectivity through WAPs that send and receive data over various electromagnetic frequencies (e.g., radio frequencies), including WAPs that support Institute of Electrical and Electronics Engineers (IEEE) 802.11 standards (e.g., 802.11g, 802.11n, and so forth), and other standards.

In various examples, distributed computing resources 102 include devices 106(1)-106(M). Examples support scenarios where device(s) 106 can include one or more computing devices that operate in a cluster or other grouped configuration to share resources, balance load, increase performance, provide fail-over support or redundancy, or for other purposes. Device(s) 106 can belong to a variety of categories or classes of devices such as traditional server-type devices, desktop computer-type devices, mobile-type devices, special purpose-type devices, embedded-type devices, and/or wearable-type devices. Thus, although illustrated as a single type of device, device(s) 106 can include a diverse variety of device types and are not limited to a particular type of device. Device(s) 106 can represent, but are not limited to, desktop computers, server computers, web-server computers, personal computers, mobile computers, laptop computers, tablet computers, wearable computers, implanted computing devices, telecommunication devices, automotive computers, network enabled televisions, thin clients, terminals, personal data assistants (PDAs), game consoles, gaming devices, Internet of Things (IoT) devices, work stations, media players, personal video recorders (PVRs), set-top boxes, cameras, integrated components (i.e., peripheral devices) for inclusion in a computing device, appliances, or any other sort of computing device.

Device(s) 106 can include any computing device having one or more processing unit(s) 108 operably connected to computer-readable media 110 such as via a bus 112, which in some instances can include one or more of a system bus, a data bus, an address bus, a PCI bus, a Mini-PCI bus, and any variety of local, peripheral, and/or independent buses. Executable instructions stored on computer-readable media 110 can include, for example, an operating system 114, encryption tool 116, and other modules, programs, or applications that are loadable and executable by processing units(s) 108. Alternatively, or in addition, the functionally described herein can be performed, at least in part, by one or more hardware logic components such as accelerators. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. For example, an accelerator can represent a hybrid device, such as one from ZYLEX or ALTERA that includes a CPU embedded in an FPGA fabric.

Device(s) 106 can also include one or more network interfaces 118 to enable communications between computing device(s) 106 and other networked devices such as client computing device(s) 120. Such network interface(s) 118 can include one or more network interface controllers (NICs) or other types of transceiver devices to send and receive communications over a network. For simplicity, other components are omitted from the illustrated device(s) 106.

Other devices configured to implement data encryption techniques can include client computing devices, for example one or more of devices 120(1)-120(N). Client computing device(s) 120 can belong to a variety of categories or classes of devices, which can be the same as, or different from, device(s) 106, such as traditional client-type devices, desktop computer-type devices, mobile-type devices, special purpose-type devices, embedded-type devices, and/or wearable-type devices. Client computing device(s) 120 can include, but are not limited to, a laptop computer 120(1), a tablet computer 120(2), telecommunication devices such as a mobile phone 120(3), computer navigation type client computing devices such as satellite-based navigation systems including global positioning system (GPS) devices and other satellite-based navigation system devices, a mobile phone/tablet hybrid, a personal data assistant (PDA), a personal computer, other mobile computers, wearable computers, implanted computing devices, desktop computers, automotive computers, network-enabled televisions, thin clients, terminals, game consoles, gaming devices 120(4), Internet of Things (IoT) devices 120(N), work stations, media players, personal video recorders (PVRs), set-top boxes, cameras, integrated components (e.g., peripheral devices) for inclusion in a computing device, appliances, or any other sort of computing device.

Client computing device(s) 120 of the various categories or classes and device types, such as the illustrated laptop computer 120(1), can represent any type of computing device having one or more processing unit(s) 122 operably connected to computer-readable media 124 such as via a bus 126, which in some instances can include one or more of a system bus, a data bus, an address bus, a PCI bus, a Mini-PCI bus, and any variety of local, peripheral, and/or independent buses.

Executable instructions stored on computer-readable media 124 can include, for example, an operating system 128, encryption tool 116, and other modules, programs, or applications that are loadable and executable by processing units(s) 122.

Client computing device(s) 120 can also include one or more network interfaces 130 to enable communications between client computing device(s) 120 and other networked devices, such as other client computing device(s) 120 or device(s) 106 over network(s) 104. Such network interface(s) 130 can include one or more network interface controllers (NICs) or other types of transceiver devices to send and receive communications over a network.

In the example of FIG. 1, device(s) 106 and client computing device(s) 120 can use encryption tool 116 to send and receive encrypted messages to each other. For instance, client computing device(s) 120 can use encryption tool 116 to encrypt data, which can include, for example, plaintext (e.g., messages or information) or binary data (e.g., a string of ones and zeros), in order to generate an encrypted message. Client computing device(s) 120 can then send the encrypted message to device(s) 106. In response, device(s) 106 can use encryption tool 116 to decrypt the encrypted message. Device(s) 106 can further use encryption tool 116 to encrypt additional data in order to generate another encrypted message, and send the encrypted message to client computing device(s) 120.

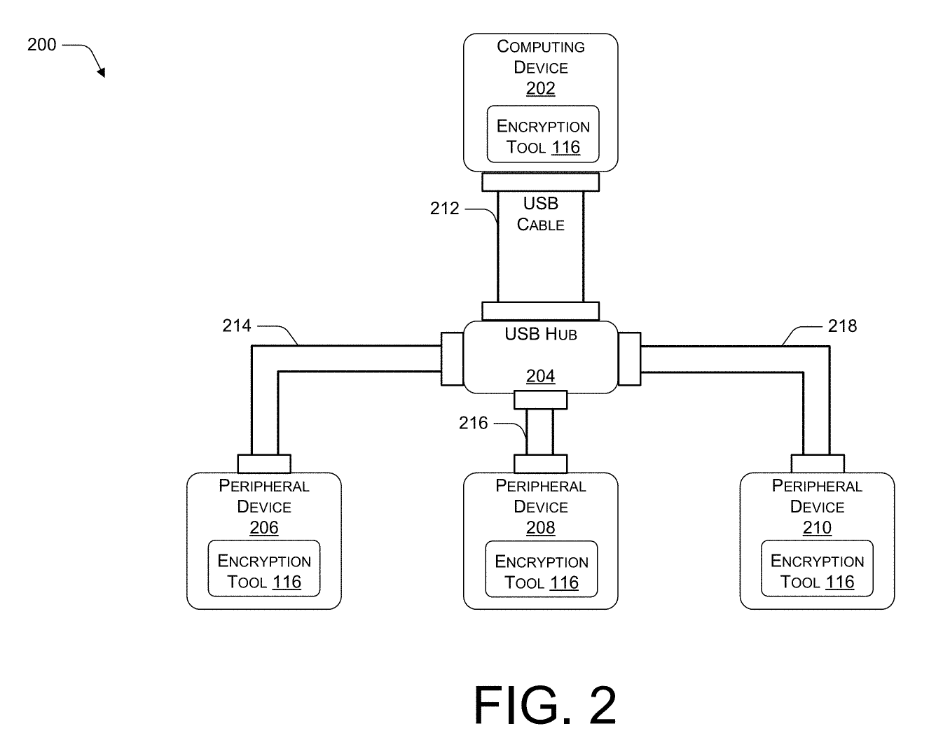

FIG. 2 illustrates an example environment 200 in which data encryption techniques can operate using peripheral devices of a computing device. Example environment 200 includes a computing device 202, which can represent one of device(s) 106 and/or client computing device(s) 120, a USB hub 204, and any number of peripheral devices, such as peripheral devices 206, 208, and 210. In the illustrated example, computing device 202 is connected to the USB hub 204 using a USB cable 212. Peripheral devices 206, 208, and 210 are connected to the USB hub 204 using USB cables 214, 216, and 218, respectively. In an example, USB cable 212 is implemented as a USB Type-C cable, which supports the USB 3.1 standard and the USB power delivery standard. According to the USB power delivery standard, along with data, electrical power is transmitted through the USB cable 212, and the power delivery may be bi-directional.

Peripheral devices 206, 208, and 210 may represent any of a variety of devices including, but not limited to, a display device, a keyboard, a mouse, a printer, a memory stick, a blue ray player, a network interface, a smartphone, and so on. Furthermore, in another example, one or more peripheral devices may be connected to computing device 202 via a USB cable, without using a USB hub.

Also illustrated in FIG. 2, each of computing device 202 and peripheral devices 206, 208, and 210 include an encryption tool 116. The peripheral devices 206, 208, and 210 can use the encryption tool 116 to encrypt data in order to generate encrypted messages, and to decrypt received encrypted messages in order to generate the data that was encrypted. As such, the peripheral devices 206, 208, and 210 are able to exchange encrypted messages with the computing device 202 and/or with another one or the peripheral devices 206, 208, and 210. As discussed above, in some examples, the encryption tool 116 uses a pseudo-random number generator to encrypt and decrypt data, which requires only minimal processing power and memory storage. In such examples, electronic devices, such as the peripheral devices 206, 208, and 210, that may not have a lot of processing power and/or memory storage, can still use encryption tool 116 to encrypt data and decrypt encrypted messages.

It should be noted that, in some examples, computing device 202 and peripheral devices 206, 208, and 210 can communicate with each other using methods other than USB Hub 204. For instance, in some examples, the computing device 202 and peripheral devices 206, 208, and 210 can communicate using public networks such as the Internet, private networks such as an institutional and/or personal intranet, or some combination of private and public networks. The networks can also include any type of wired and/or wireless network, including but not limited to local area networks (LANs), wide area networks (WANs), satellite networks, cable networks, Wi-Fi networks, WiMax networks, mobile communications networks (e.g., 3G, 4G, and so forth), Bluetooth networks, or any combination thereof. Network(s) 104 can utilize communications protocols, including packet-based and/or datagram-based protocols such as internet protocol (IP), transmission control protocol (TCP), user datagram protocol (UDP), or other types of protocols. Moreover, network(s) 104 can also include a number of devices that facilitate network communications and/or form a hardware basis for the networks, such as switches, routers, gateways, access points, firewalls, base stations, repeaters, backbone devices, and the like.

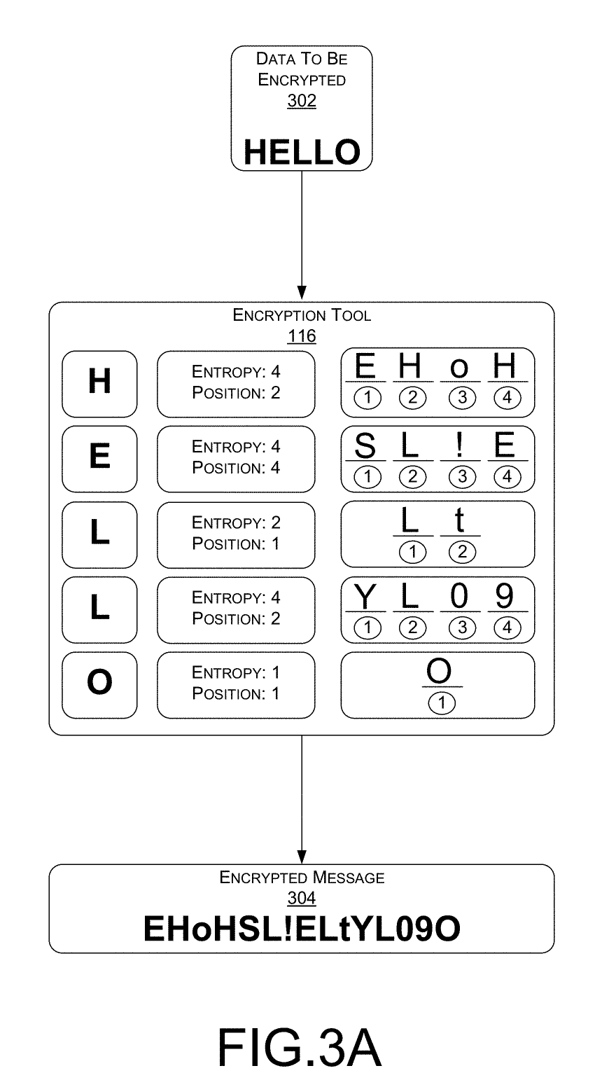

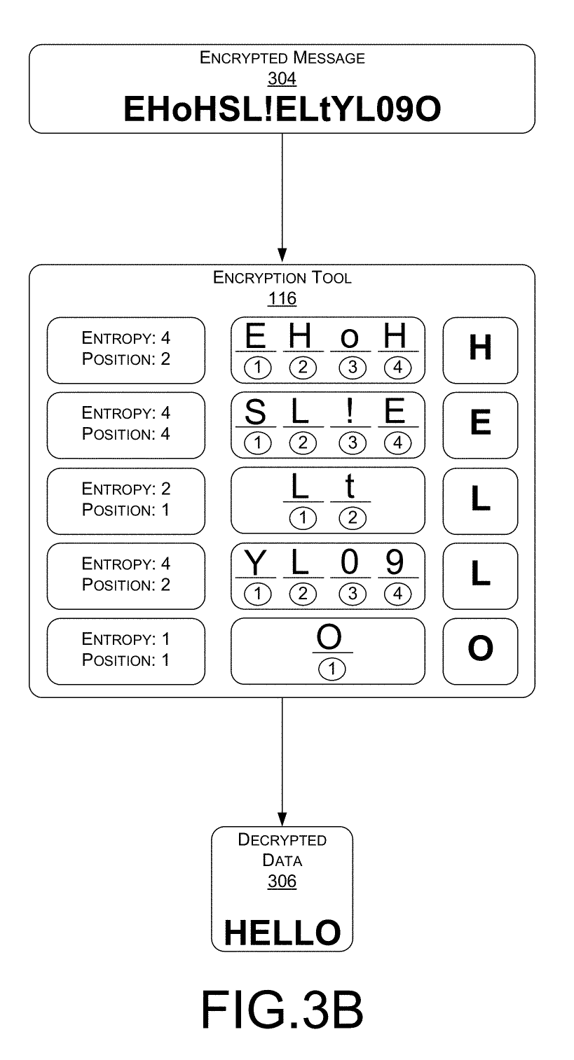

FIGS. 3A-3B illustrate an example of utilizing data encryption techniques. In the example of FIGS. 3A-3B, encryption tool 116 encrypts data to be encrypted 302. Data to be encrypted 302 can include plaintext (e.g., a message and/or information for encryption) and/or binary data. For instance, in the Example of FIGS. 3A-3B, data to be encrypted 302 includes a string of characters corresponding to a message. The message includes the characters “H”, “E”, “L”, “L”, and “O”.

To encrypt the data to be encrypted 302, encryption tool 116 generates an encrypted string for each of the characters of the data to be encrypted 302. In some examples, the encryption tool 116 uses a pseudo-random number generator to generate an entropy for the encrypted string. The entropy defines a number of positions within the encrypted string. The encryption tool 116 can further use the pseudo-random number generator to determine a position for the character within the encrypted string. The encryption tool 116 then places the character at the determined position within the encrypted string. Additionally, in some examples, the encryption tool 116 uses the pseudo-random number generator to place random characters at each of the other positions within the encrypted string.

For instance, in the example, character “H” is assigned an entropy of “4” and a position of “2”. Using the entropy and the position for the character “H”, the encryption tool 116 generates an encrypted string having four characters with the character to be encrypted in the second position, that is “EHoH”. The encryption tool 116 then uses a similar technique to generate an encrypted string for each of the remaining characters. For instance, the encrypted string for the character “E” is “SL!E”, the encrypted string for the character “L” is “Lt”, the encrypted string for the character “L” is “YL09”, and the encrypted string for the character “O” is “O”.

In some examples, the encryption tool 116 can use the encrypted strings to generate an encrypted message 304. For instance, the encryption tool 116 can concatenate each of the encrypted strings together in order to generate the encrypted message 304. In some examples, the encryption tool 116 concatenates the encrypted strings together based on a position of the characters within the data to be encrypted 302. For instance, in the illustrated example, the encrypted string for the character “H” is placed before the encrypted string for the character “E”. The encrypted string for the first character “L” is placed after the encrypted string for the character “E”. The encrypted string for the second character “L” is placed after the encrypted string for the first character “L”. Finally, the encrypted string for the character “O” is placed after the encrypted string for the second character “L”. In the example, the encryption tool 116 generates an encrypted message that includes “EHoHSL!ELtYL09O”.

The encryption tool 116 can further decrypt the encrypted message 304 using a similar technique. To decrypt the encrypted message 304, the encryption tool 116 uses the pseudo-random number to determine an entropy and a position for a first character in the encrypted message 304. Using the determined entropy, the encryption tool 116 identifies a first encrypted string within the encrypted message 304. The encryption tool 116 then uses the determined position to identify the first character within the encrypted string. In some examples, the encryption tool 116 continues identifying each of the remaining characters within the encrypted message 304 using a similar technique. The encryption tool 116 then concatenates each of the identified characters in order to generate the decrypted data. For instance, in the illustrated example, the encryption tool 116 decrypts the encrypted message 304 in order to generate the decrypted data 306 that includes the string of characters “HELLO”.

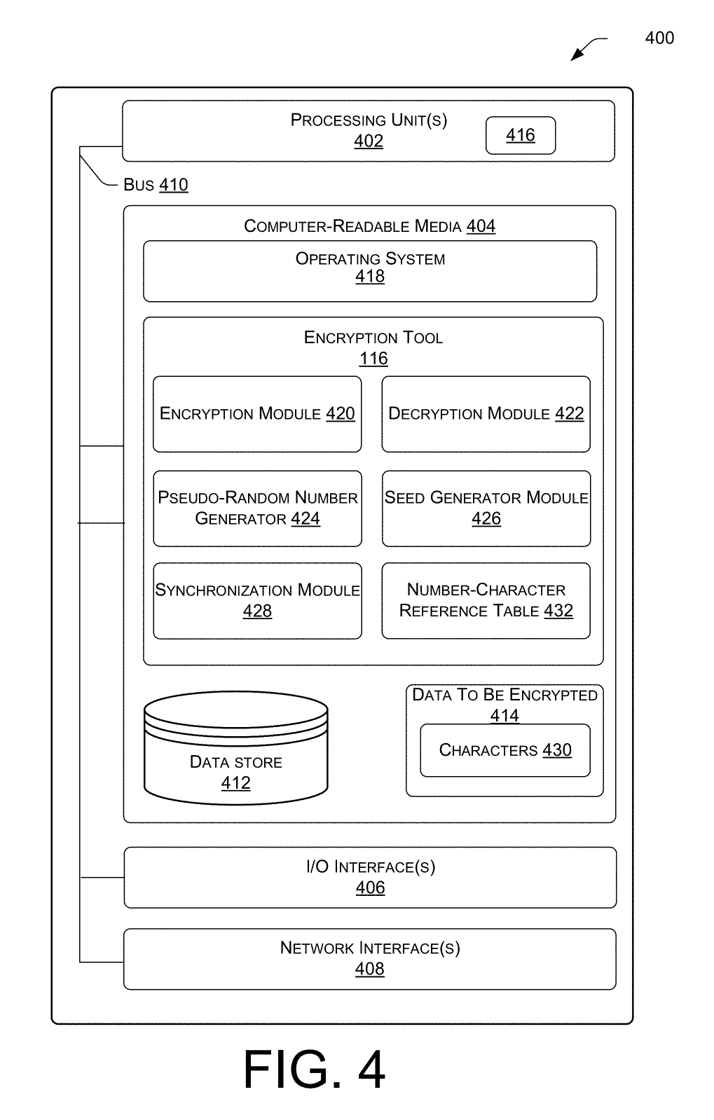

FIG. 4 illustrates select components of an example computing device 400 configured to implement data encryption techniques. Computing device 400 can represent device(s) 106 and/or client computing device 120. Example computing device 400 includes one or more processing unit(s) 402, computer-readable media 404, input/output interface(s) 406, and network interface(s) 408. The components of computing device 400 are operatively connected, for example, via a bus 410, which can represent bus 112 and/or bus 126.

In example computing device 400, processing unit(s) 402 may correspond to processing unit(s) 108 and/or processing unit(s) 122, and can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-chip systems (SOCs), Complex Programmable Logic Devices (CPLDs), etc.

Computer-readable media 404 may correspond to computer-readable media 110 and/or computer-readable media 124, and can store instructions executable by the processing unit(s) 402. Computer-readable media 404 can also store instructions executable by external processing units such as by an external CPU, an external GPU, and/or executable by an external accelerator, such as an FPGA type accelerator, a DSP type accelerator, or any other internal or external accelerator. In various examples at least one CPU, GPU, and/or accelerator is incorporated in computing device 400, while in some examples one or more of a CPU, GPU, and/or accelerator is external to computing device 400.

Computer-readable media 404 may include computer storage media and/or communication media. Computer storage media can include volatile memory, nonvolatile memory, and/or other persistent and/or auxiliary computer storage media, removable and non-removable computer storage media implemented in any method or technology for storage of information such as computer-readable instructions, data structures, program modules, or other data. Computer-readable media 404 can be examples of computer storage media. Thus, the computer-readable media 404 includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Input/output (I/O) interfaces 406 allow computing device 400 to communicate with input/output devices such as user input devices including peripheral input devices (e.g., a keyboard, a mouse, a pen, a game controller, a voice input device, a touch input device, a gestural input device, and the like) and/or output devices including peripheral output devices (e.g., a display, a printer, audio speakers, a haptic output, and the like).

Network interface(s) 408, which may correspond to network interface(s) 118 and/or network interface(s) 130, can represent, for example, network interface controllers (NICs) or other types of transceiver devices to send and receive communications over a network.

In the illustrated example, computer-readable media 404 includes a data store 412. In some examples, data store 412 includes data storage such as a database, data warehouse, or other type of structured or unstructured data storage. In some examples, data store 412 includes a corpus and/or a relational database with one or more tables, indices, stored procedures, and so forth to enable data access including one or more of hypertext markup language (HTML) tables, resource description framework (RDF) tables, web ontology language (OWL) tables, and/or extensible markup language (XML) tables, for example. Data store 412 can store data for the operations of processes, applications, components, and/or modules stored in computer-readable media 404 and/or executed by processing unit(s) 402 and/or accelerator(s). In some examples, data store 412 can store encryption tool 116 and/or data to be encrypted 414. Alternately, some or all of the above-referenced data can be stored on separate memories 416 on board one or more processing unit(s) 402 such as a memory on board a CPU-type processor, a GPU-type processor, an FPGA-type accelerator, a DSP-type accelerator, and/or another accelerator.

In the illustrated example of FIG. 4, computer-readable media 404 also includes operating system 418, which can represent operating system 114 and/or operating system 128. Additionally, computer-readable media 404 includes encryption tool 116 and data to be encrypted 414. Encryption tool 116 can include one or more modules, which are illustrated as blocks 420, 422, 424, 426, and 428, although this is just an example, and the number can vary higher or lower. Functionality described associated with blocks 420, 422, 424, 426, and 428 can be combined to be performed by a fewer number of modules or it can be split and performed by a larger number of modules.

Encryption tool 116 includes logic to program processing unit(s) 402 of computing device 400 to perform the data encryption techniques described herein. In some examples, encryption tool 116 uses encryption module 420 to generate encrypted strings for characters 430 of data to be encrypted 414. Data to be encrypted 414 can include, for example, plaintext and/or binary data that computing device 400 encrypts using encryption tool 116. As such, characters 430 include one or more characters within the data to by encrypted 414. For instance, characters 430 can include one or more letters, numbers, symbols, punctuation marks, spaces, or the like within data to be encrypted 414.

To generate an encrypted string for a character 430, the encryption module 420 calls the pseudo-random number generator 424 to determine an entropy (i.e., first random number) and a position (i.e., second random number) for the character 430. The entropy is a variable that represents the length (i.e., number of positions) of the encrypted string to use for the character 430. In some examples, the pseudo-random number generator 424 generates a pseudo-random entropy using a range, such as between two and ten characters. In some examples, the encryption module 420 determines the entropy based on a set number of characters, such as three characters. In some examples, the pseudo-random number generator 424 generates the pseudo-random entropy based on a maximum or minimum number, such as no more than five characters or no less than ten characters. In any of the examples, the pseudo-random number generator 424 can determine the range, set number, maximum, or minimum, and/or the encryption module 420 can be given the range, set number, maximum, or minimum. For instance, a user can input the range, set number, maximum, or minimum that the user wants to use when determining the entropy for a given character 430.

The position is a variable that represents a position for the character 430 within the encrypted string. In some examples, the encryption module 420 uses the pseudo-random number generator 424 to determine the position for the character 430 using the entropy for the character. For instance, the pseudo-random number generator 424 can determine a pseudo-random number between the first position of the encrypted string and the last position of the encrypted string. For example, if the entropy for the character 430 is four, then the pseudo-random number generator 424 generates a pseudo-random number corresponding to the first position, the second position, the third position, or the fourth position within the encrypted string.

After determining the entropy and the position for the character 430 in the encrypted string, the encryption module 420 places the character 430 at the determined position within the encrypted string. The encryption module 420 further calls on the pseudo-random number generator 424 to generate random characters, which the encryption module 420 places at each of the remaining positions within the encrypted string. In some examples, when the pseudo-random number generator 424 generates a random character that is the same as the character 430, the pseudo-random number generator 424 generates a new random character.

The encryption module 420 can further generate an encrypted message. In some examples, the encrypted message can include the encrypted version of the data to be encrypted 414. To generate the encrypted message, the encryption module 420 can concatenate together each of the encrypted strings for the data to be encrypted 414. In some examples, the encryption module 420 concatenates the encrypted strings together based on a position of each character 430 in the data to be encrypted 414. For instance, the encrypted string for the second character 430 of the data to be encrypted 414 is placed after the encrypted string of the first character 430 of the data to be encrypted 414, and the encrypted string for the third character 430 of the data to be encrypted 414 is placed after the encrypted string of the second character 430 of the data to be encrypted 414, etc. Additionally or alternatively, the encryption module 420 can concatenate each of the encrypted strings together using a random order as determined, for example, using pseudo-random number generator 424.

Additionally or alternatively, in some examples, encryption module 420 can utilize the pseudo-random number generator 424 to generate individual encrypted strings for more than one of the characters 430 of the data to be encrypted 414. In such examples, pseudo-random number generator 424 can generate an entropy (i.e., number of positions) for an encrypted string. The encryption module 420 can then place a random character at each position of the encrypted string. Additionally, pseudo-random number generator 424 can generate a random number representing positions in the encrypted string for each of the two or more characters 430. After determining the positions of the two or more characters 430, encryption module 420 can use the determined positions to replace the random characters in the encrypted string with the two or more characters 430 from the data to be encrypted 414.

In some examples, the encryption tool 420 can use number-character reference table 432 to offset one or more characters 430 before encrypting the data to be encrypted 414 and/or to offset one or more characters within a generated encrypted string. In some examples, number-character reference table 432 can include an ASCII table. In some examples, number-character reference table 432 can include a different table that associates characters with values.

The encryption tool 116 can use the decryption module 422 to decrypt an encrypted message. To decrypt an encrypted message, the decryption module 422 calls on the pseudo-random number generator 424 to determine an entropy and position for each of the characters that are encrypted within the encrypted message. The decryption module 422 can then use the entropy and position for each character to identify the characters within the encrypted message and concatenate the identified characters together.

It should be noted that, in some examples, the encryption tool 116 can use more than one pseudo-random number generator to perform the operations described above. For example, the encryption module 420 can use more than one pseudo-random number generator to encrypt characters 430 of the data to be encrypted 414 when generating the encrypted message. For another example, the encryption module 420 can use a first pseudo-random number generator for generating an encrypted message, and a second pseudo-random number generator for decrypting a received encrypted message.

Seed generator module 426 includes logic to program processing unit(s) 402 of computing device 400 to generate seeds for use with pseudo-random number generator 424. For instance, encryption tool 116 can utilize seed generator module 426 to generate one or more seeds for the pseudo-random number generator 424. In some examples, the seed generator module 426 generates a seed based on input from a user. For example, the user may provide the encryption tool 116 with a password that the seed generator module 426 uses to generate a seed. For another example, the seed generator module 426 can use a password and/or seed that the computing device 400 receives from another electronic device to generate a seed.

Additionally or alternatively, in some examples, the seed generator module 426 automatically generates a seed without user input. To generate a seed, the seed generator module 426 can utilize a defined value that is known between the computing device 400 and an electronic device that the computing device 400 is communicating with. For instance, the seed generator module 426 can generate a seed using time. In some examples, the time can include a specific time, such a time of day (e.g., 3:22 a.m., 4:50 p.m., or the like). Additionally or alternatively, in some examples, the time can include a relative time measured from a specific event. For example, the time can include zero minutes when the computing device 400 starts communicating with another electronic device using the encryption tool 116.

In some examples, the seed generator module 426 can continuously generate new seeds while computing device 400 is communicating with another electronic device using the encryption tool 116. For instance, the seed generator module 426 can periodically generate new seeds while the electronic devices communicate. For example, and using the example above where time includes zero minutes when the electronic devices start communicating, the seed generator module 426 can generate a new seed each minute during the communication between the electronic devices.

Synchronization module 428 includes logic to program processing unit(s) 402 of computing device 400 to synchronize the pseudo-random number generator 424 with an additional pseudo-random number generator being utilized by another electronic device. To synchronize the pseudo-random number generators, the synchronization module 428 can use the pseudo-random number generator 424 to encrypt the data to be encrypted 414 using a generated seed in order to generate an encrypted message. As discussed above, the seed generator module 426 can generate the seed based on input received from a user and/or based on a defined value that is known between the devices. As such, only an electronic device that includes both the pseudo-random number generator 424 and the correct seed can decrypt the encrypted message.

After generating the encrypted message, the computing device 400 can send the encrypted message to the other electronic device. The other electronic device can then send a response to the encrypted message, such as another encrypted message. The computing device 400 can use the other encrypted message to determine whether the pseudo-random number generators are synchronized together. For instance, in some examples, the encrypted message sent by the computing device 400 to the other electronic device can include a question. As such, the synchronization module 428 can determine that the pseudo-random number generators are synchronized based on the other encrypted message including a correct answer to the question.

In some examples, the response to the encrypted message can include the decrypted message. For instance, the computing device 400 can encrypt a message and send the encrypted message to the other electronic device. The computing device 400 can then receive the message back from the other computing device. In response to receiving the message, the synchronization module 428 can determine that the pseudo-random number generators are synchronized.

In some examples, the synchronization module 428 can further continuously or periodically determine that the pseudo-random number generators are synchronized while the electronic devices communicate. For instance, as discussed above, the seed generator module 426 may continuously or periodically generate new seeds while the encrypted messages are being sent and received between the electronic devices. As such, the synchronization module 428 can use the process above at set and/or random time intervals to determine whether the pseudo-random number generators stay synchronized when new seeds are generated.

It should be noted that, in some examples, the computing device 400 and/or a user of the computing device 400 can specify whether or not to encrypt the data to be encrypted 414. For instance, a user may be using the computing device 400 to send and receive messages with another electronic device. While sending messages, the user may determine that a specific message should be encrypted. To encrypt the specific message, in some examples, the user may input a string of characters within the specific message (e.g., “encrypt”) that the encryption tool 116 identifies. The encryption tool 116 can then encrypt that specific message based on identifying the string of characters.

It should further be noted that, in the example of FIG. 4, the encryption tool 116 is stored in the computer-readable media 404 of the computing device 400. In such an example, the encryption tool 116 can include a software application loaded onto the computing device 400. However, in some examples, the encryption tool 116 can be incorporated in the firmware of the computing device 400. Additionally or alternatively, in some examples, the encryption tool 116 can include a programmable hardware array connected to the computing device 400 and/or detachable from the computing device 400.

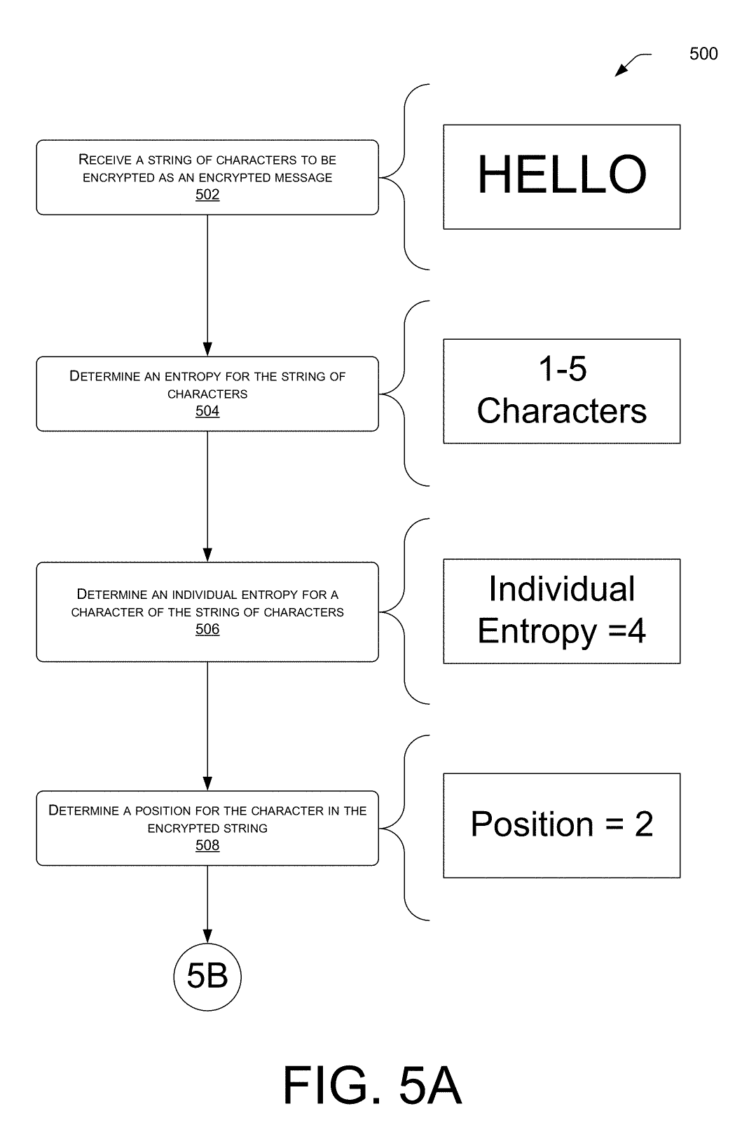

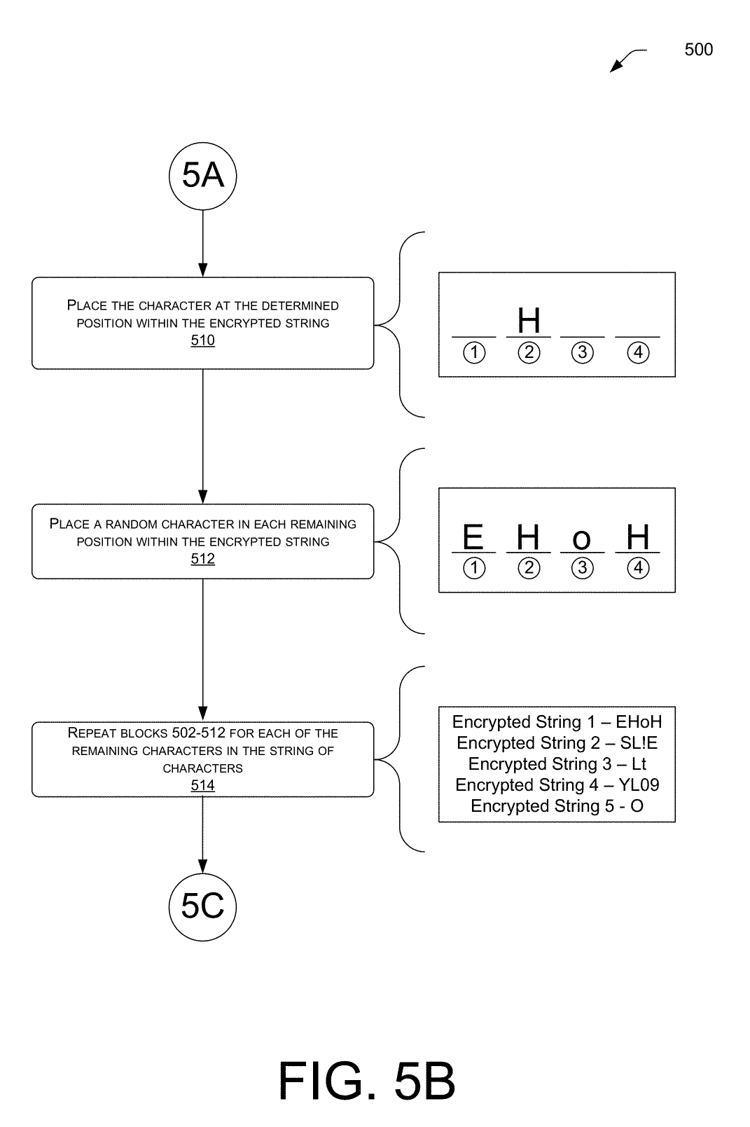

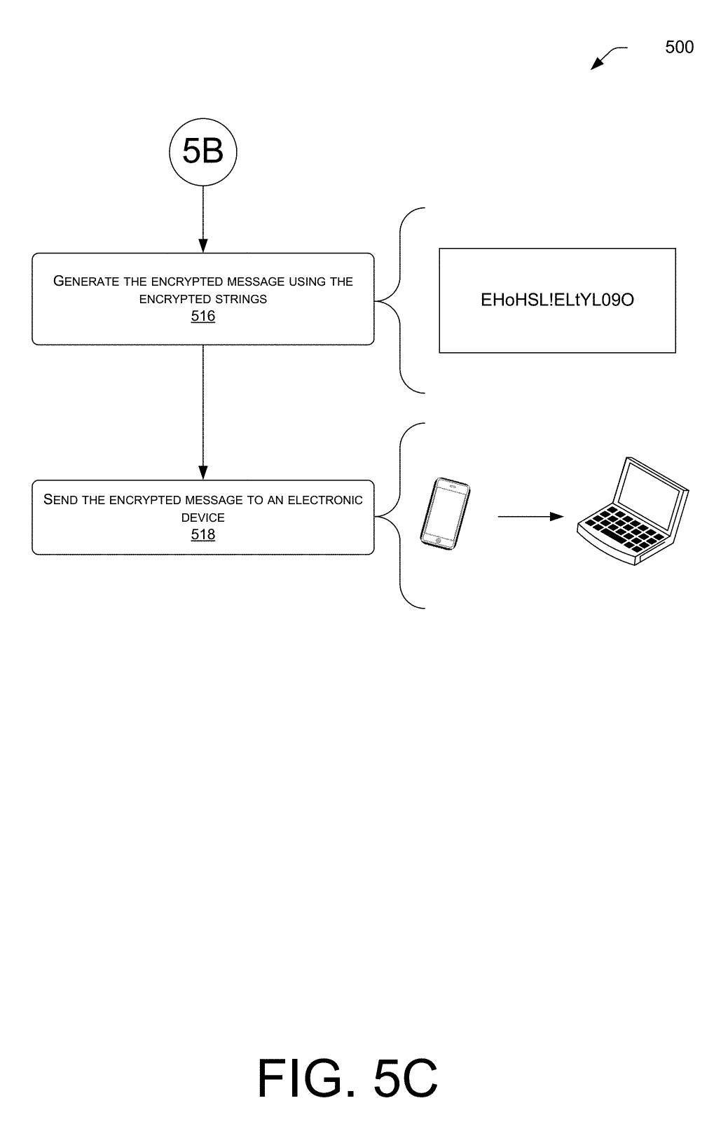

FIGS. 5A-11 illustrate example processes for performing data encryption techniques described herein. The example processes are illustrated as a collection of blocks in a logical flow graph, which represent a sequence of operations that can be implemented in hardware, software, or a combination thereof. The blocks are referenced by numbers. In the context of software, the blocks represent computer-executable instructions stored on one or more computer-readable media that, when executed by one or more processing units (such as hardware microprocessors), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

FIGS. 5A-5C illustrate a pictorial flow diagram 500 of an example method for encrypting data in order to generate an encrypted message. At block 502, a string of characters to be encrypted as an encrypted message is received. For instance, encryption tool 116 can receive data to be encrypted 414 to be encrypted into the encrypted message. Data to be encrypted 414 can include plaintext and/or binary data, which includes a string of characters 430. In some examples, encryption tool 116 receives the data to be encrypted 414 from an application executing on computing device 400, such as a messaging application, social media application, or the like. In the example of FIGS. 5A-5C, the data to be encrypted includes the word “HELLO,” with the string of characters including “H”, “E”, “L”, “L”, and “O”.

At block 504, an entropy for the string of characters is determined. For instance, in some examples, encryption module 420 can call on the pseudo-random number generator 424 to determine an entropy for the characters 430. Additionally or alternatively, encryption tool 116 may receive user input that specifies the entropy for the characters 430. As discussed above, the entropy can include a maximum entropy (e.g., a maximum of ten characters), a minimum entropy (e.g., no less than five characters), a range (between three and ten characters), or a set number (e.g., the entropy is five characters). In the example of FIGS. 5A-5C, the entropy includes a range between one and five characters.

At block 506, an individual entropy for a character of the string of characters is determined. For instance, the encryption module 420 can call on the pseudo-random number generator 424 to determine an entropy for one of the characters 430, wherein the entropy for the character 430 defines a length of an encrypted string for the character 430. In some examples, the entropy for the character 430 is based on the entropy that is determined for the string of characters 430, as described above with reference to block 502. For instance, in the example of FIGS. 5A-5C, the individual entropy for the character “H” is set to four characters, which is determined as a random value between one and five.

At block 508, a position for the character in the encrypted string is determined. For instance, the encryption module 420 can call on the pseudo-random number generator 424 to randomly generate a position for the character 430 in the encrypted string. As discussed above, the position can include any position between a first position in the encrypted string (e.g., position one) and a last position in the encrypted string (e.g., the value of the individual entropy). In the example of FIGS. 5A-5C, the position is the second position.

At block 510, the character is placed at the determined position within the encrypted string. For instance, the encryption module 420 can place the character 430 at the position within the encrypted string. In the example of FIGS. 5A-5C, the character “H” is placed at the second position in the encrypted string, which has a total of four characters.

At block 512, random characters are placed in each remaining position within the encrypted string. For instance, the encryption module 420 can call on the pseudo-random number generator 424 to generate random characters to be placed at each remaining position within the encrypted string. In the example of FIGS. 5A-5C, the character “E” is placed at the first position, the character “o” is placed at the third position, and the character “H” is placed at the fourth position within the encrypted string.

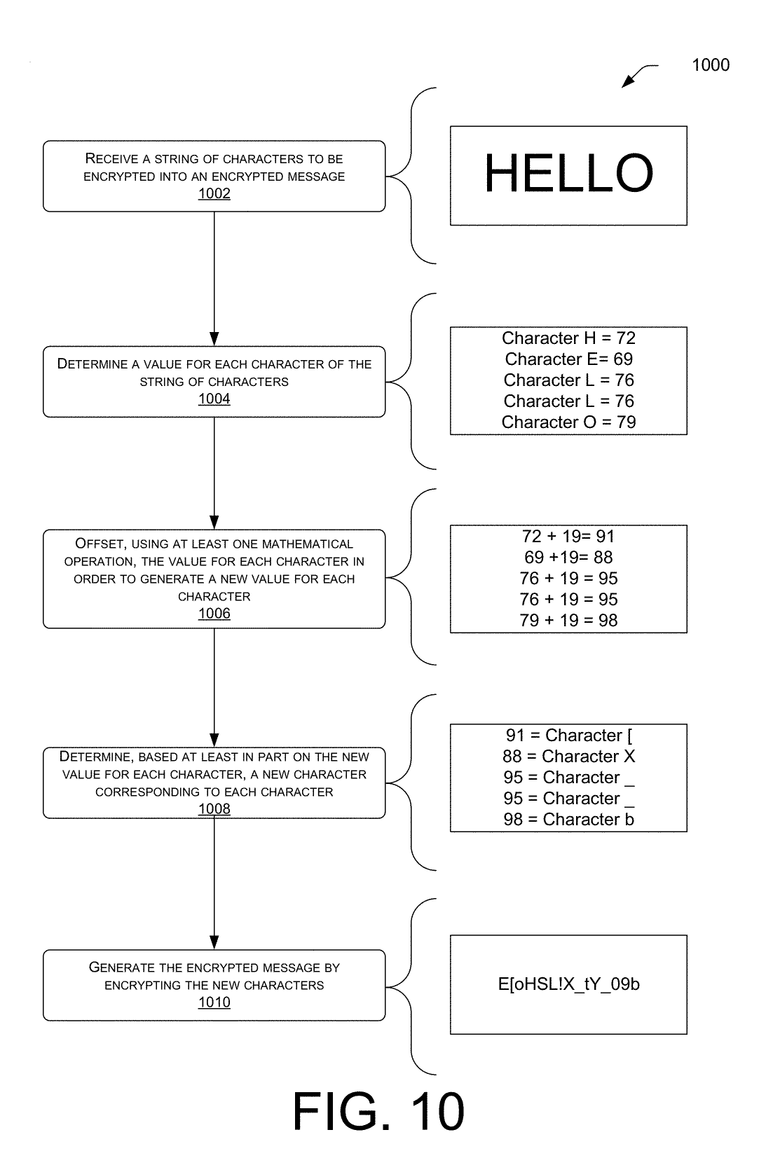

It should be noted that, in some examples, the encryption module 420 can further utilize the number-character reference table 432 to offset one or more characters within the encrypted string. For instance, the encryption module 420 can determine values for each of the characters included the encrypted string using the number-character reference table 432. The encryption module 420 can then apply a mathematical formula to the values in order to determine new values for each of the characters. Using the number-character reference table 432, the encryption module 420 can identify new characters that correspond to each of the new values and replace the characters within the encrypted string with the new characters. An example technique for offsetting characters is described with reference to FIG. 10.

At block 514, blocks 502 through 512 are repeated for each of the remaining characters in the string of characters. For instance, encryption module 420 can perform the processes described above for each character 430 in the data to be encrypted 414. Performing the processes above for each of the remaining characters 430 will generate an encrypted string for each of the remaining characters 430. In the example of FIGS. 5A-5C, the encrypted string for the character “H” is “EHoH”, the encrypted string for the character E is “SL!E”, the encrypted string for the character “L” is “Lt”, the encrypted string for the character “L” is “YL09”, and the encrypted string for the character “O” is “O”.

At block 516, the encrypted message is generated using the encrypted strings. For instance, the encryption module 420 can concatenate the encrypted strings in order to generate the encrypted message. In some examples, concatenating the encrypted strings includes linking the encrypted strings together in a chain or series based on positions of the characters 430 in the data to be encrypted 414. For instance, in the example of FIGS. 5A-5C, the encrypted message includes the encrypted string for the character “H”, followed by the encrypted string for the character “E”, followed by the encrypted string for the character “L”, followed by the encrypted string for the character “L”, and finally followed by the encrypted string for the character “O”. As illustrated, the encrypted message includes “EHoHSL!ELtYL090.”

At block 518, the encrypted message is sent to an electronic device. For instance, the computing device 400 may send the encrypted message to another electronic device. The other electronic device can then decrypt the encrypted message using an encryption tool 116 stored on the other electronic device. In the example of FIGS. 5A-5C, a mobile phone sends the encrypted message to a laptop computer.

It should be noted that in addition to, or instead of, sending the encrypted message to the electronic device, the computing device 400 can further store the encrypted message. For instance, the computing device 400 can store the encrypted message in the computer-readable media 404 of the computing device 400. The computing device 400 can then later decrypt the encrypted message using the encryption tool 116.

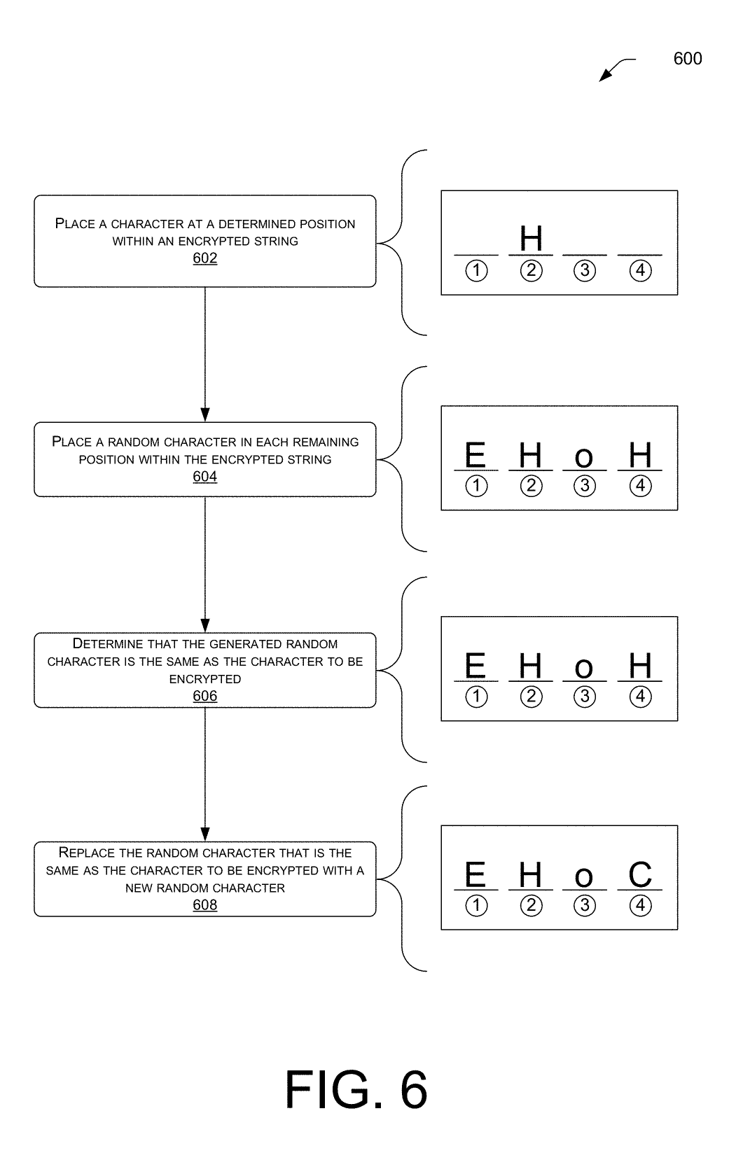

FIG. 6 illustrates a pictorial flow diagram 600 of an example method for generating an encrypted string in which the encoded character appears only once. The example is optional, and can occur within block 512 discussed above (blocks 602 and 604 corresponds to blocks 510 and 512 above). At block 602, a character is placed at a determined position within an encrypted string. For instance, the encryption module 420 can place the character 430 at a determined position within an encrypted string. In the example of FIG. 6, the character “H” is placed at the second position in the encrypted string.

At block 604, random characters are placed in each remaining position within the encrypted string. For instance, the encryption module 420 can utilize the pseudo-random number generator 424 to place random characters at each remaining position within the encrypted string. In the example of FIG. 6, the character “E” is placed at the first position, the character “o” is placed at the third position, and the character “H” is placed at the fourth position within the encrypted string.

At 606, it is determined that the generated random character is the same as the character to be encrypted. For instance, the encryption module 420 can determine that the character 430 is the same as a random character within the encrypted string. In the example of FIG. 6, the character “H” is the same as the random character “H” at the fourth position in the encrypted string.

At 608, the random character that is the same as the character to be encrypted is replaced with a new random character. For instance, the encryption module 420 can utilize the pseudo-random number generator 424 to replace the random character with a new random character. In the example of FIG. 6, the encryption module utilizes the pseudo-random number generator to replace the character “H” in the fourth position of the encrypted string with the new random character “C”.

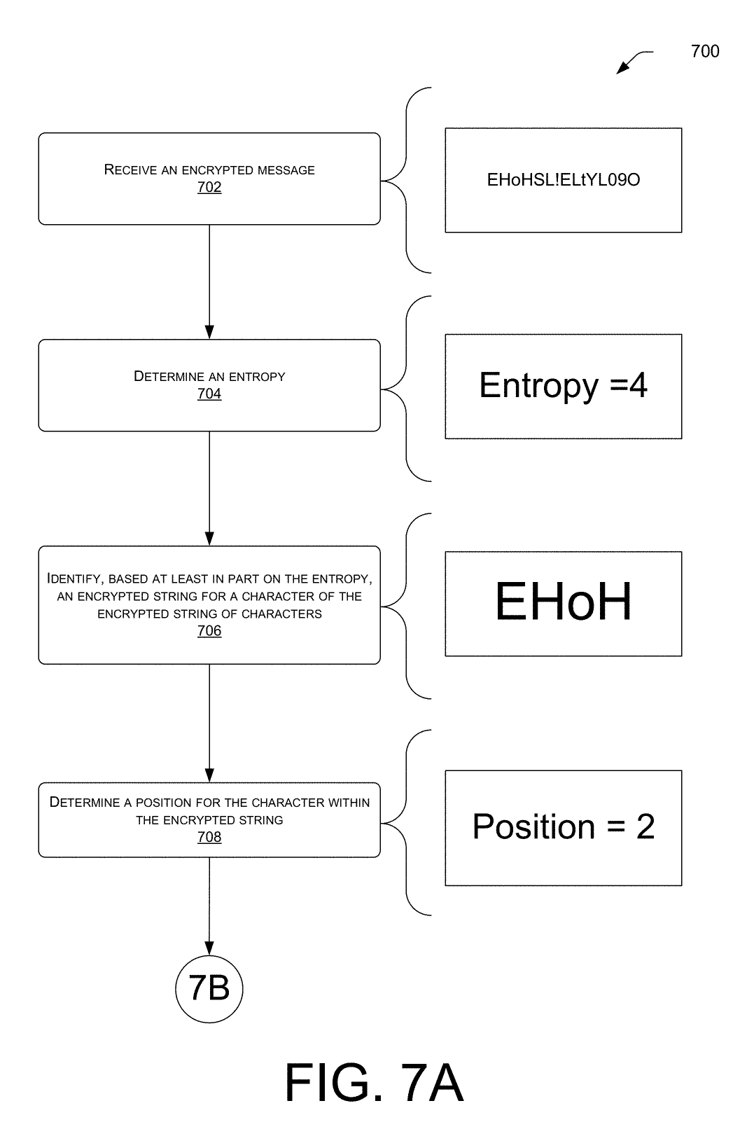

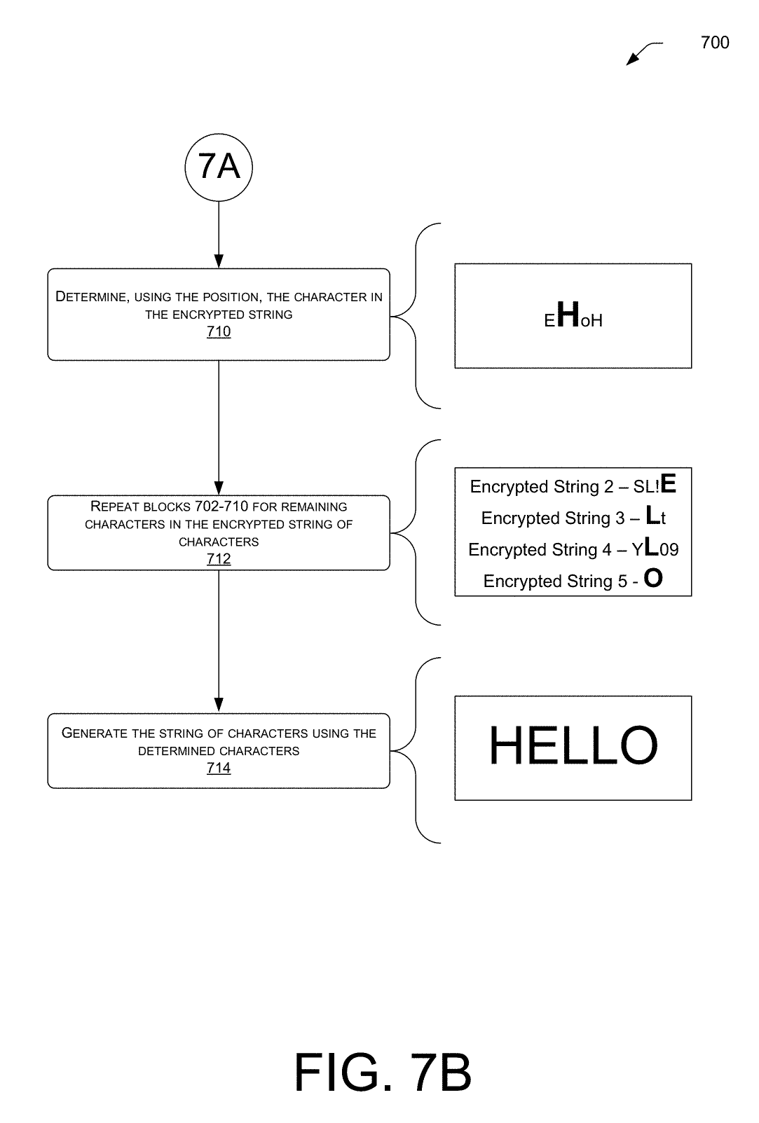

FIGS. 7A-7B illustrate a pictorial flow diagram 700 of an example method for decrypting an encrypted message that was encrypted according to the techniques described above with reference to FIGS. 5A-5C. Even though the example is described with respect to computing device 400 now receiving an encrypted message, the example can be performed by another computing device that includes an encryption tool 116. At block 702, an encrypted message is received from an electronic device, the encrypted message corresponding to an encrypted string of characters. For instance, the computing device 400 can receive an encrypted message from an electronic device. The encrypted message can correspond to a string of characters that was encrypted by the electronic device. In the example of FIGS. 7A-7B, the encrypted message includes “EHoHSL!ELtYL09O”.

At block 704, an entropy is determined. For instance, the decryption module 422 can utilize the pseudo-random number generator 424 to determine an entropy, wherein the entropy defines a length of an encrypted string for a first character of the encrypted string of characters. For instance, in the example of FIGS. 7A-7B, the entropy for the first character is four characters. To ensure that the random numbers generated when decrypting the message are the same as the random numbers generated when the message was encrypted, the pseudo-random number generator used to decrypt the message corresponds to, and is synchronized with the pseudo-random number generator that encrypted the encrypted message.

At 706, an encrypted string for a character of the encrypted string of characters is identified based at least in part on the entropy. For instance, decryption module 422 can identify an encrypted string within the encrypted message using the determined entropy. The encrypted string corresponds to a first number of characters in the encrypted message that are associated with the entropy. For instance, in the example of FIGS. 7A-7B, the encrypted string corresponds to the first four characters of the encrypted string, which include “EHoH”.

At block 708, a position for the character within the encrypted string is determined. For instance, the decryption module 422 can utilize the pseudo-random number generator 424 to determine a position of the first character in the encrypted string. In the example of FIGS. 7A-7B, the position for the first character is the second position in the encrypted string.

At block 710, the character in the encrypted string is determined using the position. For instance, decryption module 422 can determine the character in the identified encrypted string using the position. In the example of FIGS. 7A-7B, the character in the second position of the encrypted string is the character “H”.

At block 712, blocks 702 through 710 are repeated for each of the remaining characters in the string of characters. For instance, decryption module 422 can continue to determine an entropy, identify an encrypted string, and determine a position for each encrypted character in the encrypted message. The decryption module 522 can then determine each encrypted character using the entropy, the encrypted string, and the position. In some examples, the decryption module 422 continues to determine characters within the encrypted message until the decryption module 422 hits an end of the encrypted message. For instance, in the example of FIGS. 7A-7B, character “E” was identified from the encrypted string “SL!E”, character “L” was identified from the encrypted string “Lt”, character “L” was identified from the encrypted string “YL09”, and character “O” was identified from the encrypted string “O”

At block 714, the string of characters is generated using the determined characters. For instance, the decryption module 422 can determine the string of characters using each of the encrypted characters that the decryption module 422 determines are in the encrypted message. In some examples, the decryption module 422 generates the string of characters by concatenating the determined characters together. In the example of FIGS. 7A-7B, the string of characters includes “HELLO”.

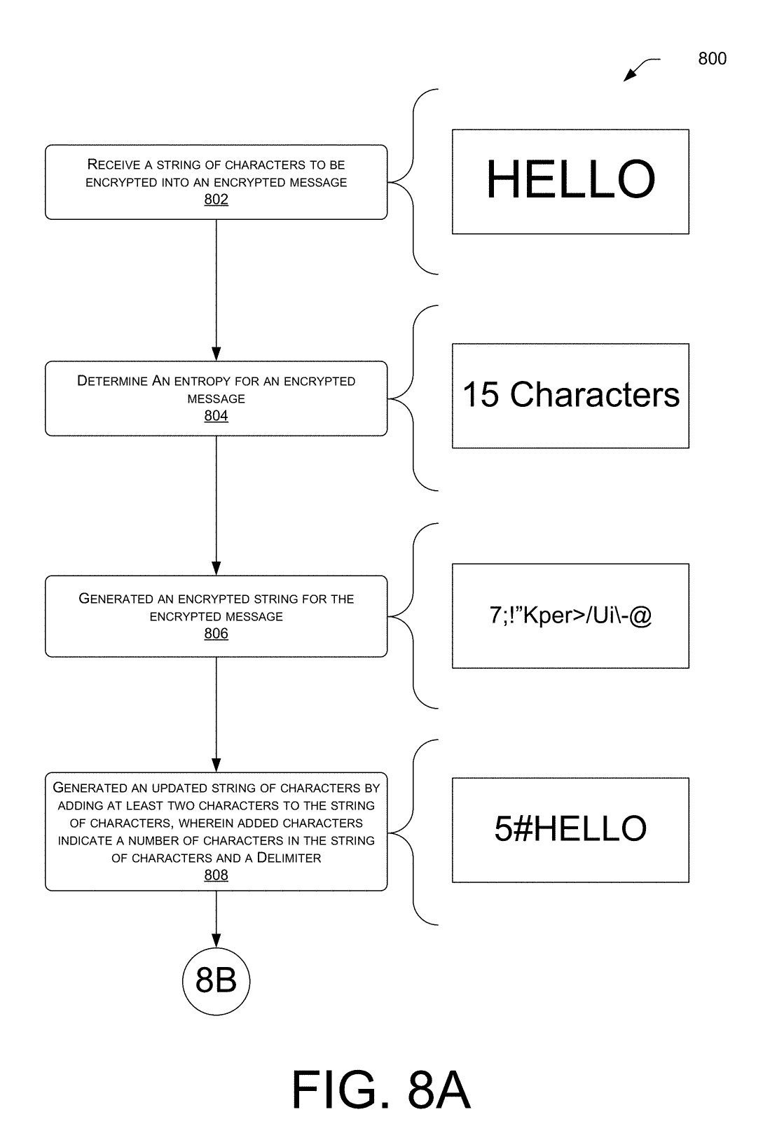

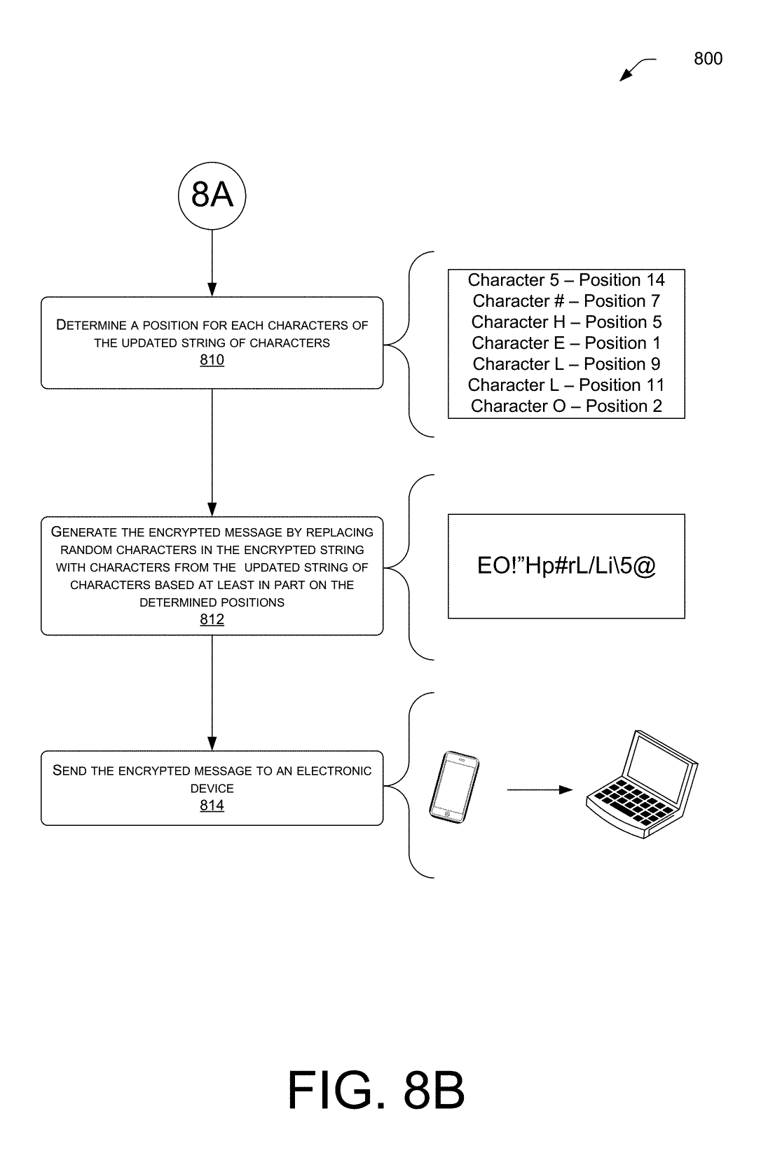

FIGS. 8A-8B illustrate a pictorial flow diagram 800 of another example method for encrypting data in order to generate an encrypted message. At block 802, a string of characters to be encrypted into an encrypted message are received. For instance, encryption tool 116 can receive data to be encrypted 414. Data to be encrypted 414 can include a string of characters 430. In some examples, encryption tool 116 receives the data to be encrypted 414 from an application executing on computing device 400, such as a messaging application, social media application, or the like. In the example of FIGS. 8A-8B, the data to be encrypted includes the word “HELLO,” with the string of characters including “H”, “E”, “L”, “L”, and “O”.

At block 804, an entropy for an encrypted message is determined. For instance, in some examples, encryption module 420 can utilize the pseudo-random number generator 424 to determine an entropy for the string of characters 430. Additionally or alternatively, encryption module 420 may receive user input that specifies the entropy for the string of characters 430. In the example of FIGS. 8A-8B, the entropy for the string of characters is fifteen characters.

At block 806, an encrypted string is generated for the encrypted message. For instance, encryption module 420 can utilize the pseudo-random number generator 424 to place a random character at each position of the encrypted string. In the example of FIGS. 8A-8B, the encrypted string includes fifteen characters (i.e., the entropy), and the random characters for the encrypted string include “7; !”Kper>/Ui\-@”.

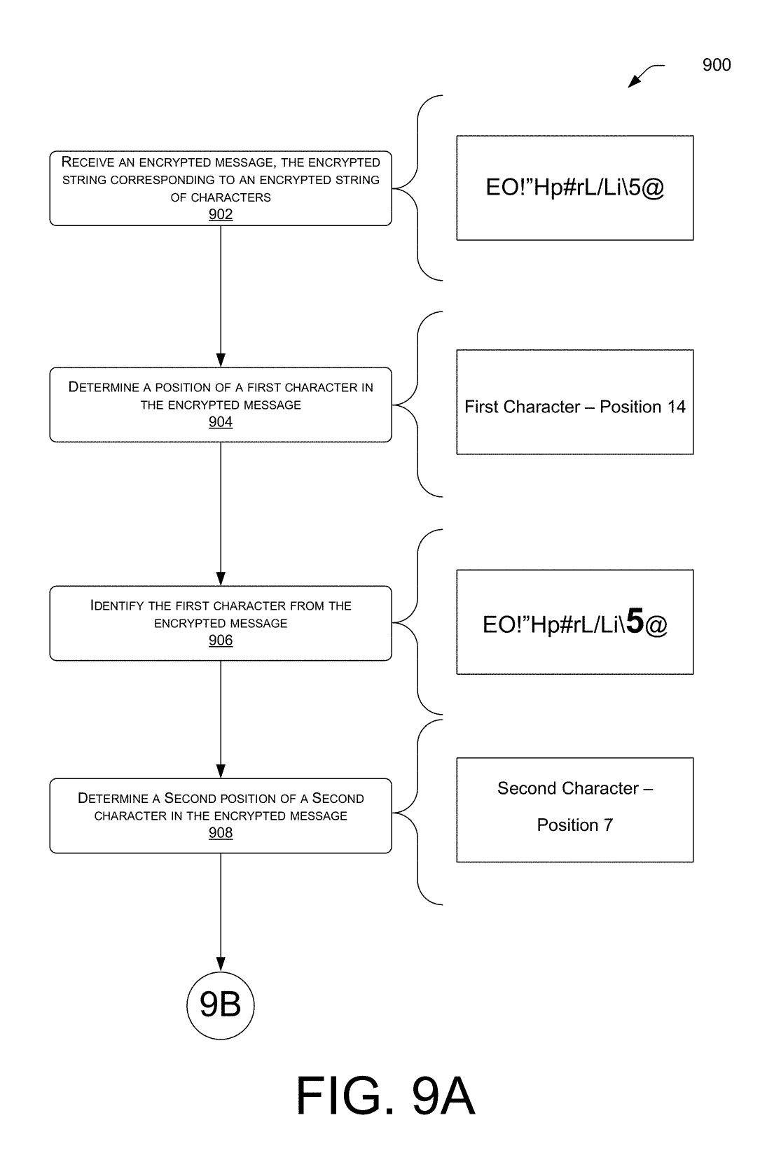

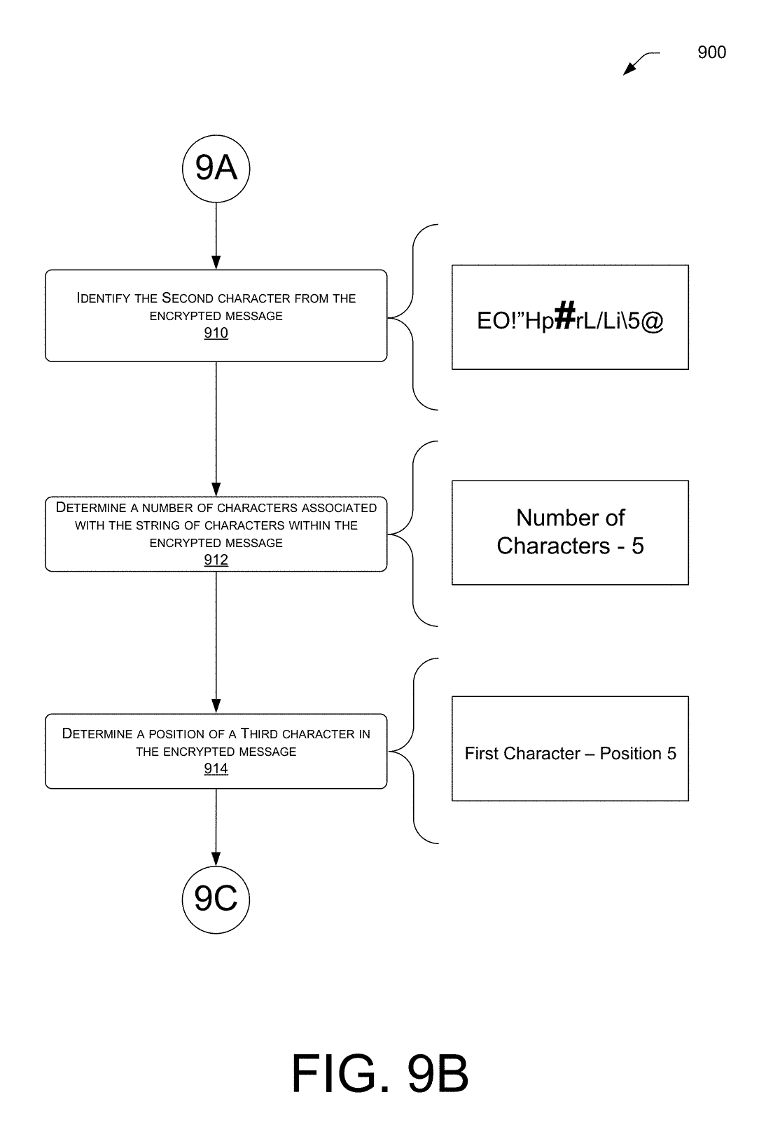

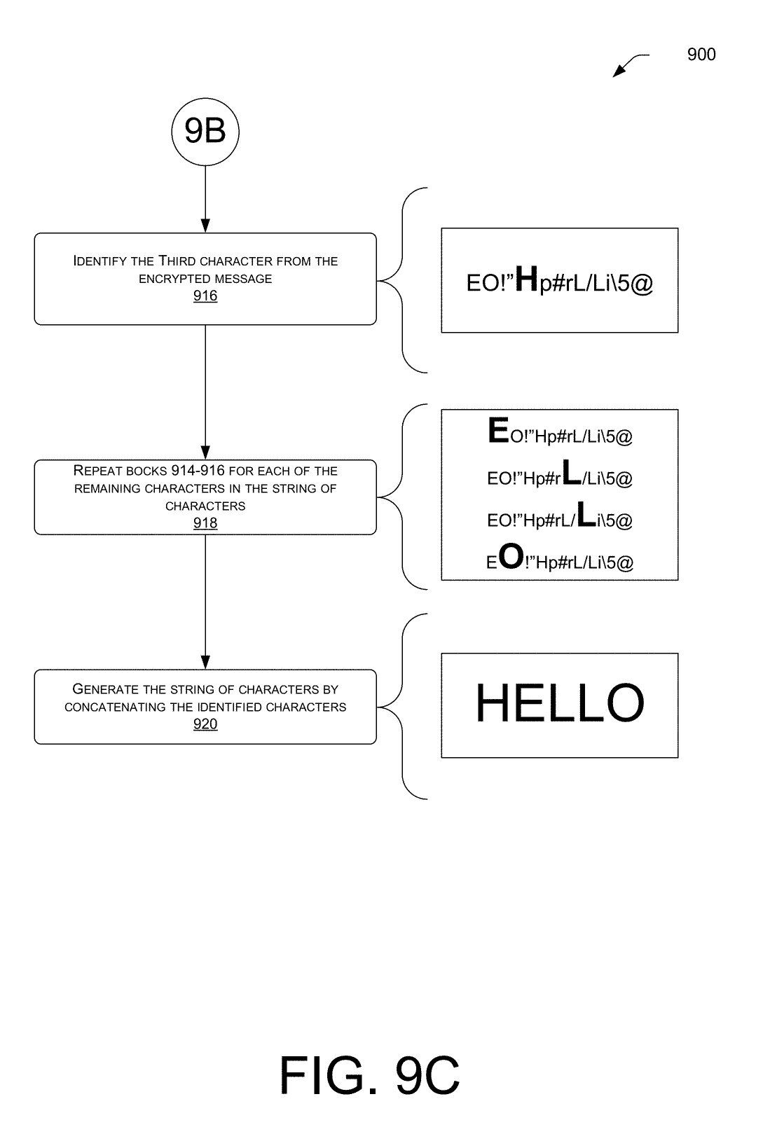

At block 808, an updated string of characters is generated by adding at least two characters to the string of characters, where the added characters indicate a number of characters in the string of characters and a delimiter. For instance, encryption module 420 generates the updated string of characters by adding to the string of characters 430, a first character that corresponds to the number of characters 430 and a delimiter. As will be discussed in FIGS. 9A-9C, the encryption module 420 adds the two characters to the string of characters 430 in order to specify to an encryption tool on another electronic device how to decrypt the encrypted message. In the example of FIGS. 8A-8B, the first character is “5” and the second character is “#”, which generates an updated string of characters of “5#HELLO”.

At block 810, a position for each character in the updated string of characters is determined. For instance, encryption module 420 can use pseudo-random number generator 424 to determine a position for each of the characters in the updated string of characters. In the example of FIGS. 8A-8B, the encryption module determines that character “5” is in position “14”, character “#” is in position “7”, character “H” is in position “5”, character “E” is in position “1”, character “L” is in position “9”, character “L” is in position “11”, and character “O” is in position “2”.

It should be noted that, in some examples, if the encryption module 420 determines an identical position for two or more of the characters within the updated character string, then the encryption module 420 determines a new position for at least one of the characters. For instance, in the example of FIGS. 8A-8B, if character “O” was originally placed at position “11”, then the encryption module 420 can utilize the pseudo-random number generator 424 to determine a new position for the character “O” because the previous character, “L”, is already at position “11”.

At block 812, the encrypted message is generated by replacing random characters in the encrypted string with the characters in the updated string of characters based at least in part on the determined positions. For instance, encryption module 420 can replace the random characters in the encrypted string at the determined positions with characters from the updated string of characters in order to generate the encrypted message. In the example of FIGS. 8A-8B, the encrypted message includes “EO!”Hp#rL/Li\5@”.

It should be noted that, in some examples, block 806 can come after block 812. For instance, the encryption module 420 can place each of the characters in the updated string in the encrypted string. The encryption module 420 can then use the pseudo-random number generator 424 to place a random character at each of the remaining positions within the encrypted string.

At block 814, the encrypted message is sent to an electronic device. For instance, the computing device 400 may send the encrypted message to another electronic device. The other electronic device can then decrypt the encrypted message using an encryption tool 116 stored on the other electronic device. In the example of FIGS. 8A-8B, a mobile phone sends the encrypted message to a laptop computer.

It should be noted that, in some examples, the encryption module 420 may not perform block 808 when generating the encrypted message. For instance, in such examples, the encryption module 420 may only replace random characters within the encrypted string with characters 430 from the data to be encrypted 414.

FIGS. 9A-9C illustrate a pictorial flow diagram 900 of an example method for decrypting an encrypted message that was encrypted according to the technique described above with regard to FIGS. 8A-8B. Even though the example is described with respect to computing device 400 now receiving an encrypted message, the example can be performed by another computing device that includes an encryption tool 116. At block 902, an encrypted message is received from an electronic device, the encrypted message corresponding to an encrypted string of characters. For instance, the computing device 400 can receive an encrypted message from an electronic device. The encrypted message can correspond to a string of characters that was encrypted by the electronic device. In the example of FIGS. 9A-9C, the encrypted message includes “EO!”Hp#rL/Li\5@”.

At block 904, a position of a first character in the encrypted message is determined and at block 906, the first character is identified from the encrypted message. For instance, the decryption module 422 can use the pseudo-random number generator 424 to determine a first position for a first character in the encrypted message. The decryption module 422 can then identify the first character in the encrypted message based on the determined first position. For instance, in the example of FIGS. 9A-9C, the decryption module uses the pseud-random number generator to determine that the position of the first character is “14”. Accordingly, the decryption module identifies the first character as “5”.

It should be noted that, in some examples, the pseudo-random number generator 424 generates a number of characters that corresponds to the number of characters in the encrypted message before generating the position of the first character. In such examples, the pseudo-random number generator 424 generates the number of characters in order to stay synchronized with the pseudo-random number generator that encrypted the message. For instance, in the example of FIGS. 9A-9C, the pseudo-random number generator 424 generates fifteen characters before generating a number that represents the position of the first character.

At block 908, a position of a second character in the encrypted message is determined and at block 910, the second character is identified from the encrypted message. For instance, decryption module 422 can use pseudo-random number generator 424 to determine a position of a second character in the encrypted message. The decryption module 422 can then identify the second character in the encrypted message based on the determined second position. For instance, in the example of FIGS. 9A-9C, the decryption module uses the pseud-random number generator to determine that the position of the second character is “7”. Accordingly, the decryption module identifies the second character as “#”.

At block 912, a number of characters associated with the string of characters within the encrypted message is determined. For instance, decryption module 422 may determine that a predefined character within the encrypted message has been identified, which indicates to the decryption module 422 how to decrypt the encrypted message. In some examples, the character can include a “#”. In such examples, the decryption module 422 can determine that the number (5) before the “#” character corresponds to a number of characters that are within the string of characters from the encrypted message. For instance, in the example of FIGS. 9A-9C, the first character “5” before the second character “#” corresponds to the number of characters associated with the string of characters that is encrypted within the encrypted message.

At block 914, a position of a third character in the encrypted message is determined and at block 916, the third character is identified from the encrypted message. For instance, decryption module 422 can use pseudo-random number generator 424 to determine a position for a third character in the encrypted message. The decryption module 422 can then identify the third character in the encrypted message based on the determined third position. For instance, in the example of FIGS. 9A-9C, the decryption module uses the pseud-random number generator to determine that the position of the second character is “5”. Accordingly, the decryption module identifies the second character as “H”.

At block 918, blocks 914 and 916 are repeated for each of the remaining characters in the string of characters. For instance, the decryption module 422 can use pseudo-random number generator 424 to determine a position for each of the remaining characters in the string of characters, and then use the positions to identify each of the remaining characters in the encrypted message. In some examples, the decryption module 422 can identify a last character in the string of characters based on the determined number of characters from block 912. In the example of FIGS. 9A-9C, the decryption module identifies the remaining characters as “E”, “L”, “L”, and “O”.

At block 920, the string of characters is generated by concatenating the identified characters. For instance, the decryption module 422 can concatenate the identified characters in order to generate the string of characters. In the example of FIGS. 9A-9C, the string of characters includes “HELLO.”

It should be noted that, in some examples, as discussed above, the encrypted message may only include the string of characters (e.g., not the additional characters “5” and “#” from the example in FIGS. 9A-9C). In such examples, the decryption module 422 may not perform blocks 902-912 of FIGS. 9A-9C when generating the string of characters from the encrypted message.

FIG. 10 illustrates a pictorial flow diagram 1000 of an example method for encrypting data that includes offsetting characters of the data before encrypting the data. At block 1002, a string of characters to be encrypted into an encrypted message is received. For instance, encryption tool 116 can receive data to be encrypted 414. Data to be encrypted 414 can include plaintext and/or binary data, which includes a string of characters 430. In some examples, encryption tool 116 receives the data to be encrypted 414 from an application executing on computing device 400, such as a messaging application, social media application, or the like. In the example of FIG. 10, the data to be encrypted includes the word “HELLO,” with the string of characters including “H”, “E”, “L”, “L”, and “O”.

At block 1004, a value is determined for each character of the string of characters. For instance, the encryption module 420 can determine a value for each character 430 in the data to be encrypted 414 using the number-character reference table 432. In some examples, the number-character reference table 432 can include the ASCII table. Additionally or alternatively, in some examples, the number-character reference table 432 can include a different table that associates characters with values. In the example of FIG. 10, the values for characters are determined using the ASCII table. For instance, the value for the character “H” is 72, the value for the character “E” is 69, the value for the character “L” is 76, the value for the character “L” is 76, and the value for the character “O” is 79.

At block 1006, the value for each character is offset using at least one mathematical operation in order to generate a new value for each character. For instance, encryption module 420 can determine a new value for each of the values using one or more mathematical operations. Mathematical operations can include adding, subtracting, multiplying, dividing, or the like. In some examples, the encryption module 420 can utilize the pseudo-random number generator 424 to perform the one or more mathematical operations on the values. In some examples, the encryption module 420 can receive user input that defines the one or more mathematical operations. In the example of FIG. 10, nineteen is added to each of the values of the characters.

Additionally, in some examples, when using the number-character reference table 432, if a mathematical operation increases the value of a character such that it is greater than the greatest value in the table, then the new value is determined by subtracting the greatest value in the table from the increased value. For instance, if the number-character reference table 432 includes the ASCII table, which has a minimum printable value of 32 and a greatest printable value of 126, and the mathematical operation includes adding 50 to 90, then the new value would be 13+32 which would equal 45.

At block 1008, a new character corresponding to each character is determined based at least in part on the new value for each character. For instance, the encryption module 420 can utilize the number-character reference table 432 to determine new characters that correspond to each of the characters in the string of characters using the new values. In the example of FIG. 10, and using the ASCII table, the new character for the character “H” is the character “[”, the new character for the character “E” is the character “X”, the new character for the character “L” is the character “_”, the new character for the character “L” is the character “_”, and the new character for the character “O” is the character “b”.

At block 1010, the encrypted message is generated by encrypting the new characters. For instance, encryption module 420 can utilize pseudo-random number generator 424 to encrypt the new characters using a similar process as discussed above for FIGS. 5A-5C, FIG. 6, or FIGS. 8A-8B. In the example of 5A-5C, the encrypted message includes “EHoHSL!ELtYL09O”. As such, in the example of FIG. 10, the encrypted message with the new characters includes “E[oHSL!X_tY_09b”.

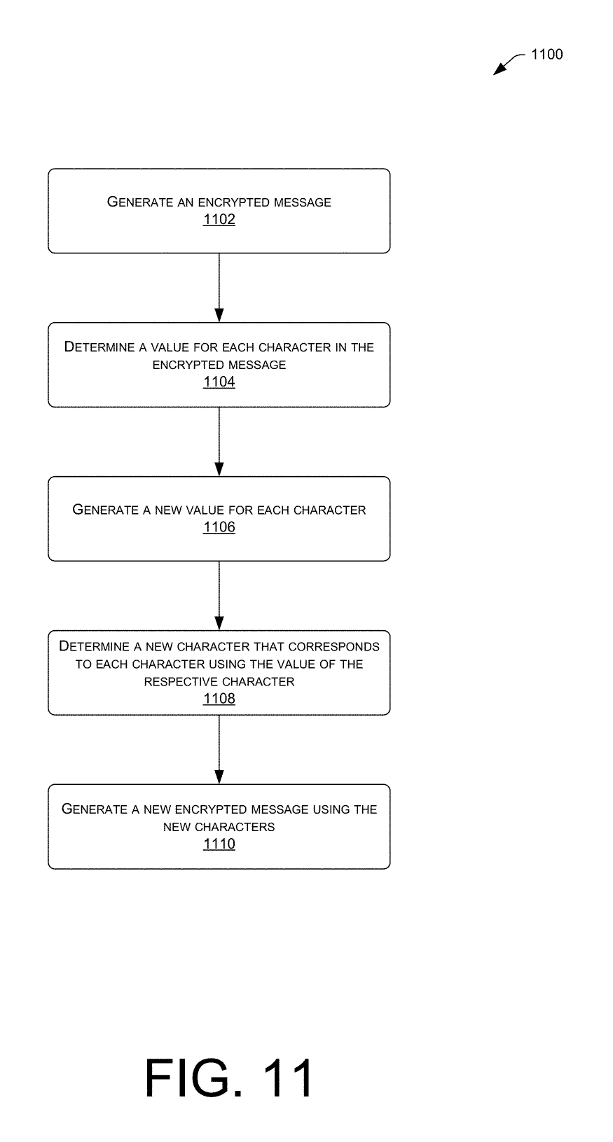

FIG. 11 is a flow diagram 1000 of an example method for encrypting data that includes offsetting characters in an encrypted message. Even though the example of FIG. 11 describes offsetting characters in an encrypted message, in some examples, a similar method can be used to offset characters in encrypted strings before the encrypted stings are concatenated to generate the encrypted message.

At block 1102, an encrypted message is generated. For example, encryption module 420 can generate an encrypted message using the techniques described above with reference to FIGS. 5A-5C, FIG. 6, and FIGS. 8A-8B. For instance, in the example described in FIGS. 5A-5C, the encrypted message for the string of characters “HELLO” is “EHoHSL!ELtYL09O”.

At block 1104, a value is determined for each character in the encrypted message. For instance, the encryption module 420 can determine a value for each character in the encrypted message using the number-character reference table 432. As discussed above, in some examples, the number-character reference table 432 can include the ASCII table. Additionally or alternatively, in some examples, the number-character reference table 432 can include a different table that associates characters with values.

At 1106, a new value for each character is generated. For instance, encryption module 420 can determine a new value for each character by performing one or more mathematical operations on the value of the respective character. Mathematical operations can include adding, subtracting, multiplying, dividing, or the like. In some examples, the encryption module 420 can utilize the pseudo-random number generator 424 to perform the one or more mathematical operations on the values. In some examples, the encryption module 420 can receive user input that defines the one or more mathematical operations.

At block 1108, a new character that corresponds to each character is determined using the new value of the respective character. For instance, the encryption module 420 can use the number-character reference table 432 to determine new characters that correspond to each of the characters in the encrypted message.

At block 1110, a new encrypted message is generated using the new characters. For instance, encryption module 420 can generate a new encrypted message by replacing each of the characters in the encrypted message with the corresponding determined new character.

It should be noted that, in the examples above, the encryption module 420 may offset any number of characters within the string of characters and/or the encrypted message. For example, the encryption module 420 can offset one or more characters, but not all of the characters in the string of characters and/or the encrypted message. Additionally or alternatively, in some examples, the encryption module 420 may offset characters in the encrypted string before encryption, and characters in the encrypted message after the encryption.

It should further be noted that, in some examples, the decryption module 422 performs the operations of the encryption module 420 when encrypting a message, but in a reverse order. As such, in such examples, the decryption module 422 can decrypt any message that the encryption module 420 encrypts.

### Example Clauses

Paragraph A: A method comprising: receiving a string of characters to be encrypted; for a character of the string of characters, generating an encrypted string by: determining a length of the encrypted string, wherein the length defines a number of positions in the encrypted string; determining a first position within the encrypted string for the character; placing the character at the first position within the encrypted string; and for a second position within the encrypted string: determining a random character for the second position; and placing the random character at the second position; and sending the encrypted string to an electronic device.

Paragraph B: A method as Paragraph A recites, wherein the encrypted string is generated using one or more pseudo-random number generators.

Paragraph C: A method as Paragraph B recites, wherein the one or more pseudo-random number generators are used to determine at least one of: the length of the encrypted string; the first position within the encrypted string; or the random character.

Paragraph D: A method as any of Paragraphs A-C recite, wherein the character of the string of characters is a first character of the string of characters and the encrypted string is a first encrypted string, the method further comprising: for a second character of the string of characters, generating a second encrypted string; and generating an encrypted message by concatenating the first encrypted string with the second encrypted string, wherein sending the encrypted string to the electronic device comprises sending the encrypted message to the electronic device.

Paragraph E: A method as any of Paragraphs A-D recite, wherein the encrypted string is further generated by: determining that the random character is the same as the character; and generating a new random character to replace the random character that is the same as the character.

Paragraph F: A method as any of Paragraphs A-E recite, further comprising: determining, using a table, a value associated with the character; offsetting the determined value in order to generate a new value; and determining, using the table, a new character that is associated with the new value, wherein generating the encrypted string comprises replacing the character with the new character at the first position within the encrypted string.

Paragraph G: A method as any of Paragraphs A-F recite, further comprising: determining a value associated with at least one of the character or the random character within the encrypted string; offsetting the determined value in order to generate a new value; determining a new character that is associated with the new value; and generating a new encrypted string by replacing the at least one of the character or the random character within the encrypted string with the new character, wherein sending the encrypted string to the electronic device comprises sending the new encrypted string to the electronic device.

Paragraph H: A method as any of Paragraphs A-G recite, wherein the encrypted string is generated using a first pseudo-random number generator, the method further comprising: receiving, from the electronic device, an additional encrypted string; and decrypting the additional encrypted string using a second pseudo-random number generator.

Paragraph I: A method as any of Paragraphs A-H recite, further comprising: receiving, from the electronic device, an encrypted message; decrypting the encrypted message by: determining a length of an encrypted string within the encrypted message; identifying the encrypted string based, at least in part, on the determined length; determining a position of an encrypted character within the encrypted string; and identifying the encrypted character within the encrypted string based at least in part on the determined position.

Paragraph J: A method as any of paragraphs A-I recite, wherein determining the first position within the encrypted string comprises determining a position between a first position of the number of positions and a last position of the number of positions.

Paragraph K: A method as any of Paragraphs A-J recite, wherein the encrypted string is generated using a pseudo-random number generator, and wherein the method further comprises generating, based at least in part on time, a seed for use with the pseudo random number generator.

Paragraph L: A method as any of Paragraphs A-K recite, wherein the encrypted string is generated by a peripheral device connected to the electronic device.

Paragraph M: A system comprising: a first electronic device configured to: receive a string of one or more characters to be encrypted; for an individual character of the string of one or more characters, generate an encrypted string by: determining, using a first pseudo-random number generator, an entropy for the encrypted string; determining, using the first pseudo random number generator, a position within the encrypted string for the individual character; placing the individual character at the position in the encrypted string; and for each remaining position in the encrypted string: determining a random character for the respective remaining position; and placing the random character at the respective remaining position; generate an encrypted message based at least in part on the encrypted string; and send the encrypted message to a second electronic device; and the second electronic device configured to: receive the encrypted message from the first electronic device; and decrypt, using a second pseudo-random number generator, the encrypted message, wherein the first pseudo-random number generator and the second pseudo-random number generator are synchronized to generate the same sequence of random numbers.

Paragraph N: A system as Paragraph M recites, wherein: the second electronic device is further configured to: generate, using a third pseudo-random number generator, an additional encrypted message; and send the additional encrypted message to the first electronic device; and the first electronic device is further configured to: receive the additional encrypted message from the second electronic device; and decrypt, using a fourth pseudo-random number generator, the additional encrypted message, wherein the third pseudo-random number generator and the fourth pseudo-random number generator are synchronized to generate the same sequence of random numbers.

Paragraph O: A system as Paragraph M or Paragraph N recites, wherein the first electronic device is further configured to generate a seed for the first pseudo-random number generator based at least in part on a time, and the second electronic device is further configured to generate a seed for the second pseudo-random number generator based at least in part on the time.

Paragraph P: A system as Paragraph O recites, wherein the time corresponds to a time that the first electronic device and the second electronic device began communicating.

Paragraph Q: A system as any of Paragraphs M-P recite, wherein: the fourth pseudo-random number generator is the first pseudo-random number generator; and the third pseudo-random number generator is the second pseudo-random number generator.

Paragraph R: One or more computer-readable media storing computer-executable instructions that, when executed on one or more processors, configure an electronic device to encrypt a string of characters by: receiving the string of characters, the string of characters including at least a first character; determining a number of positions of an encrypted string for encrypting the string of characters, the number of positions including at least a first position and a second position within the encrypted string; placing a first random character at the first position in the encrypted string; placing a second random character at the second position in the encrypted string; determining a first random position for the first character in the encrypted string, the first random position being selected from at least the first position or the second position; and based at least in part on the first random position, replacing at least one of the first random character or the second random character in the encrypted string with the first character.

Paragraph S: One or more computer-readable media as Paragraph R recites, wherein the string of characters is encrypted using one or more pseudo-random number generators.

Paragraph T: One or more computer-readable media as Paragraph R or Paragraph S recites, wherein the string of characters further includes a second character, and wherein the electronic device is further configured to encrypt the string of characters by: determining a second random position for the second character; determining that the first random position for the first character is the same as the second random position for the second character; and based at least in part on determining that the first random position is the same as the second random position, determining a new second random position for the second character.

### CONCLUSION

Although the techniques have been described in language specific to structural features and/or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) 106, 120, 202, and/or 400 such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A method comprising:
receiving a string of characters to be encrypted;
for a character of the string of characters, generating an encrypted string by:
determining a length of the encrypted string, wherein the length defines a number of positions in the encrypted string;
determining a first position within the encrypted string for the character;
placing the character at the first position within the encrypted string; and
for a second position within the encrypted string:
determining a random character for the second position; and
placing the random character at the second position; and
sending the encrypted string to an electronic device.

2. A method as recited in claim 1, wherein the encrypted string is generated using one or more pseudo-random number generators.

3. A method as recited in claim 2, wherein the one or more pseudo-random number generators are used to determine at least one of:
the length of the encrypted string;
the first position within the encrypted string; or
the random character.

4. A method as recited in claim 1, wherein the character of the string of characters is a first character of the string of characters and the encrypted string is a first encrypted string, the method further comprising:
for a second character of the string of characters, generating a second encrypted string; and
generating an encrypted message by concatenating the first encrypted string with the second encrypted string,
wherein sending the encrypted string to the electronic device comprises sending the encrypted message to the electronic device.

5. A method as recited in claim 1, wherein the encrypted string is further generated by:
determining that the random character is the same as the character; and
generating a new random character to replace the random character that is the same as the character.

6. A method as recited in claim 1, further comprising:
determining, using a table, a value associated with the character;
offsetting the determined value in order to generate a new value; and
determining, using the table, a new character that is associated with the new value,
wherein generating the encrypted string comprises replacing the character with the new character at the first position within the encrypted string.

7. A method as recited in claim 1, further comprising:
determining a value associated with at least one of the character or the random character within the encrypted string;
offsetting the determined value in order to generate a new value;
determining a new character that is associated with the new value; and
generating a new encrypted string by replacing the at least one of the character or the random character within the encrypted string with the new character,
wherein sending the encrypted string to the electronic device comprises sending the new encrypted string to the electronic device.

8. A method as recited in claim 1, wherein the encrypted string is generated using a first pseudo-random number generator, the method further comprising:
receiving, from the electronic device, an additional encrypted string; and
decrypting the additional encrypted string using a second pseudo-random number generator.

9. A method as recited in claim 1, further comprising:
receiving, from the electronic device, an encrypted message;
decrypting the encrypted message by:
determining a length of an encrypted string within the encrypted message;
identifying the encrypted string based, at least in part, on the determined length;
determining a position of an encrypted character within the encrypted string; and
identifying the encrypted character within the encrypted string based at least in part on the determined position.

10. A method as recited in claim 1, wherein determining the first position within the encrypted string comprises determining a position between a first position of the number of positions and a last position of the number of positions.

11. A method as recited in claim 1, wherein the encrypted string is generated using a pseudo-random number generator, and wherein the method further comprises generating, based at least in part on time, a seed for use with the pseudo random number generator.

12. A method as recited in claim 1, wherein the encrypted string is generated by a peripheral device connected to the electronic device.

13. A system comprising:
a first electronic device configured to:
receive a string of one or more characters to be encrypted;
for an individual character of the string of one or more characters, generate an encrypted string by:
determining, using a first pseudo-random number generator, an entropy for the encrypted string;
determining, using the first pseudo random number generator, a position within the encrypted string for the individual character;
placing the individual character at the position in the encrypted string; and
for each remaining position in the encrypted string:
determining a random character for the respective remaining position; and
placing the random character at the respective remaining position;
generate an encrypted message based at least in part on the encrypted string; and
send the encrypted message to a second electronic device; and
the second electronic device configured to:
receive the encrypted message from the first electronic device; and
decrypt, using a second pseudo-random number generator, the encrypted message, wherein the first pseudo-random number generator and the second pseudo-random number generator are synchronized to generate the same sequence of random numbers.

14. A system as recited in claim 13, wherein:
the second electronic device is further configured to:
generate, using a third pseudo-random number generator, an additional encrypted message; and
send the additional encrypted message to the first electronic device; and
the first electronic device is further configured to:
receive the additional encrypted message from the second electronic device; and
decrypt, using a fourth pseudo-random number generator, the additional encrypted message, wherein the third pseudo-random number generator and the fourth pseudo-random number generator are synchronized to generate the same sequence of random numbers.

15. A system as recited in claim 13, wherein the first electronic device is further configured to generate a seed for the first pseudo-random number generator based at least in part on a time, and the second electronic device is further configured to generate a seed for the second pseudo-random number generator based at least in part on the time.

16. A system as recited in claim 15, wherein the time corresponds to a time that the first electronic device and the second electronic device began communicating.

17. A system as recited in claim 13, wherein:
the fourth pseudo-random number generator is the first pseudo-random number generator; and
the third pseudo-random number generator is the second pseudo-random number generator.

18. One or more computer-readable media storing computer-executable instructions that, when executed on one or more processors, configure an electronic device to encrypt a string of characters by:
receiving the string of characters, the string of characters including at least a first character;
determining a number of positions of an encrypted string for encrypting the string of characters, the number of positions including at least a first position and a second position within the encrypted string;
placing a first random character at the first position in the encrypted string;
placing a second random character at the second position in the encrypted string;
determining a first random position for the first character in the encrypted string, the first random position being selected from at least the first position or the second position; and
based at least in part on the first random position, replacing at least one of the first random character or the second random character in the encrypted string with the first character.

19. One or more computer-readable media as recited in claim 18, wherein the string of characters is encrypted using one or more pseudo-random number generators.

20. One or more computer-readable media as recited in claim 18, wherein the string of characters further includes a second character, and wherein the electronic device is further configured to encrypt the string of characters by:
determining a second random position for the second character;
determining that the first random position for the first character is the same as the second random position for the second character; and
based at least in part on determining that the first random position is the same as the second random position, determining a new second random position for the second character.
